(19) United States
(12) Patent Application Publication
(10) Pub. No.: US 2024/0099495 A1
(43) Pub. Date: Mar. 28, 2024

(54) AUTOMATED AVOCADO PROCESSING SYSTEM AND RELATED METHOD

(71) Applicant: Vebu Inc., El Segundo, CA (US)

(72) Inventors: Arthur Francois David Levy, Los Angeles, CA (US); Alan Hong, Glendale, CA (US); Vahid Alizadehyazdi, Long Beach, CA (US); Amar Jyothiprakash, Los Angeles, CA (US); Aaron Lucas, Los Angeles, CA (US); Blake Edward Winner, Los Angeles, CA (US); Manomit Bal, Playa del Rey, CA (US); Praveen Nooli, Frisco, TX (US); Felix Alvarez, Tarzana, CA (US); Elvis Junior Palma, Harbor City, CA (US); Stanislav Moiseyenko, San Rafael, CA (US); Daren Miles, Burlingame, CA (US); Yuri Litvinov, San Francisco, CA (US)

(21) Appl. No.: 18/468,690

(22) Filed: Sep. 16, 2023

Related U.S. Application Data
(60) Provisional application No. 63/511,611, filed on Jun. 30, 2023.
(60) Provisional application No. 63/409,735, filed on Sep. 24, 2022.

(51) Int. Cl. A47J 17/16

(52) U.S. Cl. CPC A47J 17/16

(57) ABSTRACT

An automated avocado processing system for cutting an avocado in half, removing the pit, and extracting the flesh from the peel includes a plurality of functional assemblies arranged on a frame. Exemplary stations include a loading assembly, cutting assembly, peeling station, and food collection assembly. Computer and electronics are programmed and operable to control the automated stations. Related methods are described.

### CROSS-REFERENCE TO RELATED APPLICATIONS

This application claims priority to provisional application No. 63/409,735, filed Sep. 24, 2022, entitled “AUTOMATED AVOCADO SPLITTER SYSTEM AND RELATED METHOD” and to provisional application No. 63/511,611, filed Jun. 30, 2023 entitled “AUTOMATED AVOCADO PROCESSING SYSTEM AND RELATED METHOD.”

### BACKGROUND OF THE INVENTION

### 1. Field of the Invention

This invention relates to food processing systems, and more particularly, to automated food processing systems adapted to automatically split, depit, and peel avocados.

### 2. Description of Related Art

In the restaurant environment, various desirable food items such as guacamole are prepared using fresh avocados. The avocados are cut in equal halves and the pit is removed (hereinafter sometimes referred to as “depitted”) by hand. The process relies entirely on employee labor. In addition to being slow, tedious, and prone to injury, the amount and quality of the fruit obtained by the manual process is inconsistent. These shortcomings are exasperated when there is a need to rush or for a large quantity.

Additionally, extracting the usable flesh of the produce from the internal cores/seeds is a labor-intensive process. Flesh yield is often compromised due to the difficulty of the adherence of the flesh to the seed and the rush for deliverables arising in commercial settings.

In order to automate the processing of fresh produce in a commercial kitchen setting, a system is necessary to receive, sort and store the output of the automated processing system. The system must be compact enough to fit within a commercial kitchen while also being able to sort waste products (e.g., the peels) from the edible yield (e.g., the extracted produce flesh).

Some automated solutions to the above problems have been attempted. They involve cutting through the entirety of the avocado flesh and seed, often with a rotary blade. This is undesirable because it increases the potential of contaminating the avocado flesh with chips from the pit. Additionally, in order to cut the pit, higher forces are required which are generally undesirable for in-kitchen solutions.

While some foods can be prepared in advance for an expected rush, there is still a need for fresh preparation of certain food items such as fresh avocado and guacamole. To store avocado and guacamole after they have been prepared reduces the quality of the appearance and taste to some extent. This is undesirable.

There is therefore a need for an improved avocado splitting, depitting and peeling system, and particularly, one that is automated and can quickly process multiple avocados for use in the restaurant environment.

### SUMMARY OF THE INVENTION

Embodiments of the invention include an automated produce processing system operable to perform one or more of the following functions: singulating, splitting, depitting, peeling, and separating the useable parts from the waste.

In embodiments of the invention, a system is operable to store or process a whole case or full batch of usable seeded produce. In embodiments the system includes a modular or expandable storage volume to accommodate user or specific types of fruits and vegetables.

In embodiments of the invention, a system includes a singulation station which includes a plurality of subassemblies to transfer pieces of produce from the stored batch to, ultimately, a single piece. Embodiments of the invention include one or more ramps, motorized conveyors, drums, and sensors to singulate the produce unit.

In embodiments of the invention, a system is operable to cut the fruit/vegetable.

In embodiments of the invention, a system is operable to remove the core or seed from the cut produce. In embodiments, the produce half is punched by a rod which ejects the pit.

In embodiments of the invention, a system is operable to extract the flesh from the produce half. In embodiments, a peeling system extracts the flesh from the skin.

In embodiments of the invention, a system is operable to separate the extracted flesh and the waste (e.g., the cores, skin, etc.) associated with the fruit or vegetable. In embodiments, a food holding and waste assembly directs the waste to garbage bins and the edible flesh to the food holding and storage area. In embodiments, a motorized lid and shutter assembly are operable to direct the waste to a waste area and usable food to a food holding area.

In embodiments of the invention, a system is programmed and operable to collect data from sensors or otherwise (e.g., time elapsed, count, proximity, load cell data) to create metrics for yield, throughput, etc. In embodiments, the metrics are available or sent to end user QSRs to evaluate savings, efficiencies, average consumption, etc.

In embodiments of the invention, an automated avocado splitting system for splitting and depitting an avocado includes a plurality of functional stations arranged in a frame. The functional stations include a loader, a cutter, and a dispenser.

In embodiments of the invention, the cutting assembly comprises a clamping fixture, and wherein the clamping fixture comprises a first fixture half and a second fixture half, and wherein the first fixture half and second fixture half are movable relative to one another to form an avocado-shaped cavity.

In embodiments of the invention, the avocado-shaped cavity of the clamping fixture comprises a seam.

In embodiments of the invention, the cutting assembly further comprises opposing blades adapted to close through the seam around the pit, cutting the avocado into a first part and a second part, wherein the second part contains the pit.

In embodiments of the invention, the system further comprises a motor or actuator operable to separate the first fixture half and second fixture half while the opposing blades remain closed. In embodiments of the invention, the blades further comprise a cutout to accommodate the pit.

In embodiments of the invention, the system further comprises at least one elongate member arranged to penetrate the second part of the avocado and eject the pit from the second part of the avocado through the cutout as the second fixture half is rearwardly moved.

In embodiments of the invention, the blades are retractable to allow the first and second parts of the avocado to fall from the first and second fixtures, respectively.

In embodiments of the invention, the food collection and holding assembly comprises a chute controllably tiltable to a first configuration to direct the ejected pit to a waste container, and a second configuration to direct the falling avocado parts to a food storage bin.

In embodiments of the invention, the loading assembly comprises a hopper adapted to receive a plurality of avocados in a row.

In embodiments of the invention, the first and second cutting fixtures are controllably clampable to form the avocado-shaped cavity selected from a group of different sizes. In embodiments of the invention, the different sizes include small, medium, large, and extra-large.

In embodiments of the invention, the loading assembly comprises a singulating drum.

In embodiments of the invention, the loading assembly comprises a tiltable ramp between a first home position to receive the avocado from the drum, and a second sloped position to deliver the avocado into the cutting assembly.

In embodiments of the invention, the system further comprises a dashboard comprising a plurality of user input features (e.g., levers, knobs, buttons, touch screen, etc.) and indicators (LEDS, display) to control actions (e.g., power, start stop, speed, avocado size, etc.) and show the status (e.g., on/off, error status) of the system that may prompt the user/operator to interact with the system.

In embodiments of the invention, the system further comprises a computer, power supply, and a plurality of sensors programmed and operable to control the loading, cutting and food collection and holding assemblies.

In embodiments of the invention, the automated avocado splitting system includes computer system and electronics programmed and operable to control each functional station.

In embodiments of the invention, a method for splitting and depitting an avocado comprises the steps engaging the avocado with linearly-sliding blades while leaving the pit intact, pulling the avocado halves apart, and removing the seed. In embodiments, the removing step is performed in the same motion as the pulling step.

Objects and Advantages

In embodiments of the invention, objects and advantages include one or more of the following:

An automated produce peeling mechanism or assembly operable to separate desired or usable parts of the produce (e.g., avocado flesh) from the waste (e.g., the avocado pit and skin), so as to prevent the waste from contacting or contaminating the usable parts of the produce.

An automated produce peeling mechanism or assembly operable to separate desired or usable parts of the produce (e.g., avocado flesh) from the waste (e.g., the avocado pit and skin) faster and with higher yield than a trained human operator.

An automated produce processing mechanism or assembly having a loading capacity of 1 to 5, and optionally up to a full case of avocados or other units.

An automated produce processing mechanism or assembly operable to process different or variations in size and shape of the produce that are typically inherent to fruits/vegetables.

An automated produce processing mechanism or assembly, optionally portable, and including a removable or rotating cover that is operable to function as a work surface when closed.

An automated produce processing mechanism or assembly operable to process, obtain and track data to compute a wide range of metrics including without limitation flesh yield, total avocados processed, cycle time, and food safety.

The description, objects and advantages of the present invention will become apparent from the detailed description to follow, together with the accompanying drawings.

### BRIEF DESCRIPTION OF THE DRAWINGS

FIG. 1 is left-side isometric view of an automated avocado splitting system in accordance with an embodiment of the invention;

FIG. 2 is a functional overview diagram of an automated avocado splitting system in accordance with an embodiment of the invention;

FIG. 3 is a flow chart of a method for splitting and depitting an avocado in accordance with an embodiment of the invention

FIGS. 4-6 are enlarged partial views of a loading assembly illustrating, sequentially, loading an avocado into a cutting assembly in accordance with embodiments of the invention;

FIGS. 7-8 are enlarged partial views of the cutting assembly illustrating, sequentially, cutting and separating the avocado into halves in accordance with embodiments of the invention;

FIGS. 9-11 are enlarged partial views illustrating, sequentially, depitting the avocado in accordance with embodiments of the invention;

FIGS. 12-14 are enlarged views illustrating, sequentially, dispensing the avocado halves in accordance with embodiments of the invention;

FIG. 15 is a block diagram of an automated avocado splitting system in accordance with an embodiment of the invention;

FIG. 16-17 are left-side isometric views of another automated avocado splitting system in accordance with an embodiment of the invention;

FIG. 18 is a functional overview diagram of the automated avocado splitting system shown in FIGS. 16-17;

FIG. 19 is a flow chart of a method for singulating, cutting, depitting, peeling an avocado from storage in accordance with an embodiment of the invention;

FIG. 20 is a perspective view of the loading assembly for singulating an avocado from a batch of avocados in accordance with embodiments of the invention;

FIGS. 21-22 are right-side top and top views, respectively, of the orientation assembly for centering and releasing an avocado in accordance with embodiments of the invention;

FIGS. 23-25 sequentially illustrate cooperating assemblies for orienting, releasing and clamping the avocado in accordance with embodiments of the invention;

FIGS. 26A-26B sequentially illustrating cutting the avocado into halves in accordance with embodiments of the invention;

FIG. 27 is an enlarged perspective view of a cutting assembly in accordance with an embodiment of the invention;

FIGS. 28A-28B are side views of cutting blades shaped to accommodate a large and small pit, respectively, in accordance with embodiments of the invention;

FIG. 29 is a perspective view of the cutting and peeling assemblies illustrating separating the avocado halves in accordance with embodiments of the invention;

FIGS. 30A-30C sequentially illustrate depitting an avocado half in accordance with embodiments of the invention;

FIGS. 31A-31B are front perspective and top views, respectively, of a peeling tool in accordance with an embodiment of the invention;

FIGS. 31C-31D are various enlarged partial perspective views of the peeling tool shown in FIG. 31A;

FIGS. 32A-32B sequentially illustrate peeling an avocado in accordance with embodiments of the invention;

FIG. 33A is an enlarged partial view of the roller surface shown in FIG. 31A;

FIG. 33B is an enlarged cross-sectional view of the roller shown in FIG. 31A taken along line 33B-33B;

FIGS. 33C-33D are side and top views, respectively, of one tooth of the set of teeth shown in FIG. 33A;

FIGS. 34A-40D are perspective, side, and end views of various different rollers of a peeling tool in accordance with embodiments of the invention;

FIGS. 41-42 are partial perspective views of a food collection and holding assembly shown in an uncovered configuration and a covered configuration, respectively, in accordance with embodiments of the invention; and

FIGS. 43-44 are partial perspective views of the food collection and holding assembly shown in a first closed-shutter configuration and second open-shutter configuration, respectively, in accordance with embodiments of the invention.

### DETAILED DESCRIPTION OF THE INVENTION

Before the present invention is described in detail, it is to be understood that this invention is not limited to particular variations set forth herein as various changes or modifications may be made to the invention described and equivalents may be substituted without departing from the spirit and scope of the invention. As will be apparent to those of skill in the art upon reading this disclosure, each of the individual embodiments described and illustrated herein has discrete components and features which may be readily separated from or combined with the features of any of the other several embodiments without departing from the scope or spirit of the present invention. In addition, many modifications may be made to adapt a particular situation, material, composition of matter, process, process act(s) or step(s) to the objective(s), spirit or scope of the present invention. All such modifications are intended to be within the scope of the claims made herein.

Methods recited herein may be carried out in any order of the recited events which is logically possible, as well as the recited order of events. Furthermore, where a range of values is provided, it is understood that every intervening value, between the upper and lower limit of that range and any other stated or intervening value in that stated range is encompassed within the invention. Also, it is contemplated that any optional feature of the inventive variations described may be set forth and claimed independently, or in combination with any one or more of the features described herein.

All existing subject matter mentioned herein (e.g., publications, patents, patent applications and hardware) is incorporated by reference herein in its entirety except insofar as the subject matter may conflict with that of the present invention (in which case what is present herein shall prevail).

Reference to a singular item, includes the possibility that there are plural of the same items present. More specifically, as used herein and in the appended claims, the singular forms “a,” “an,” “said” and “the” include plural referents unless the context clearly dictates otherwise. It is further noted that the claims may be drafted to exclude any optional element. As such, this statement is intended to serve as an antecedent basis for use of such exclusive terminology as “solely,” “only” and the like in connection with the recitation of claim elements, or use of a “negative” limitation. Last, it is to be appreciated that unless defined otherwise, all technical and scientific terms used herein have the same meaning as commonly understood by one of ordinary skill in the art to which this invention belongs.

Apparatus Overview

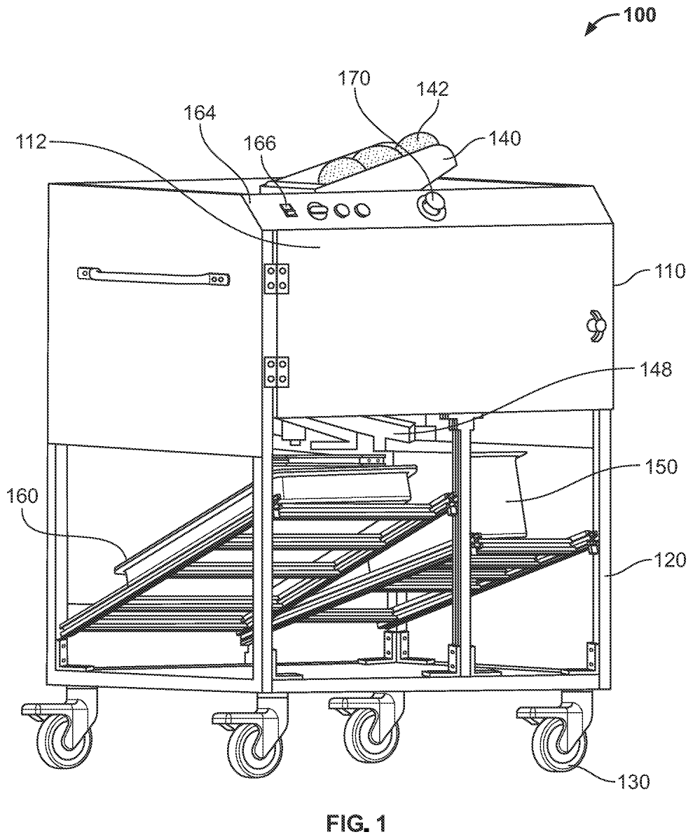

FIG. 1 shows an automated avocado splitting system 100 in accordance with an embodiment of the invention. The system 100 shown in FIG. 1 shows body 110 supported by frame 120. Castor wheels 130 are arranged on the feet of the frame to conveniently roll the system. A cutting and depitting assembly contained within the body 110, and described herein, is operable to cut the avocado in halves (or near halves), and remove the pit. A pivotable ramp 148 is operable to guide the pits into a waste container 150, and the avocado halves into food storage bin 160. A dashboard 164 is shown on the front of the body 110 including power switch 166, emergency stop 170 and various other buttons, lights, indicators, gauges for controlling operations of the system as described further herein.

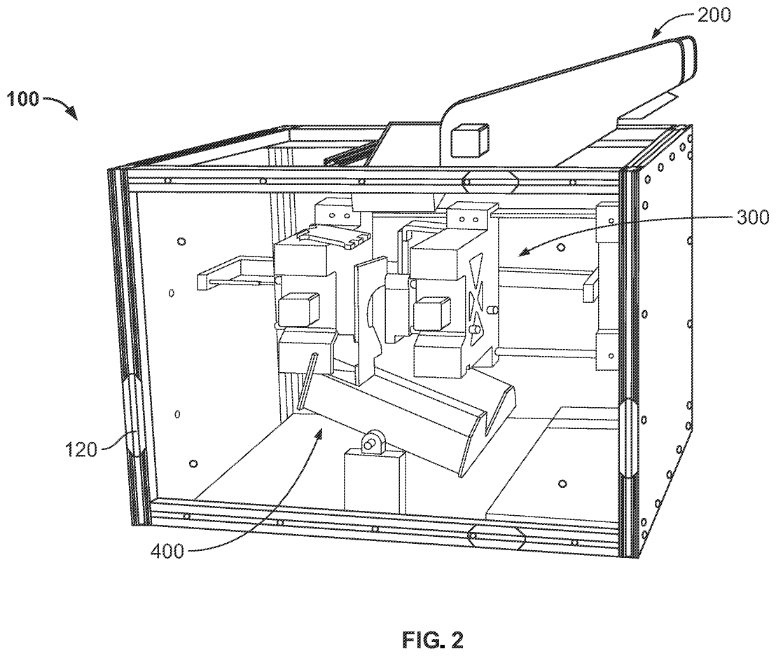

With reference to FIG. 2, an avocado splitting system 100 in accordance with an embodiment of the invention is shown with the enclosure removed for facilitating understanding of the invention. Particularly, FIG. 2 illustrates the relative arrangement of cutting assembly 300 between loading assembly 200 and dispensing assembly 400 on frame 120.

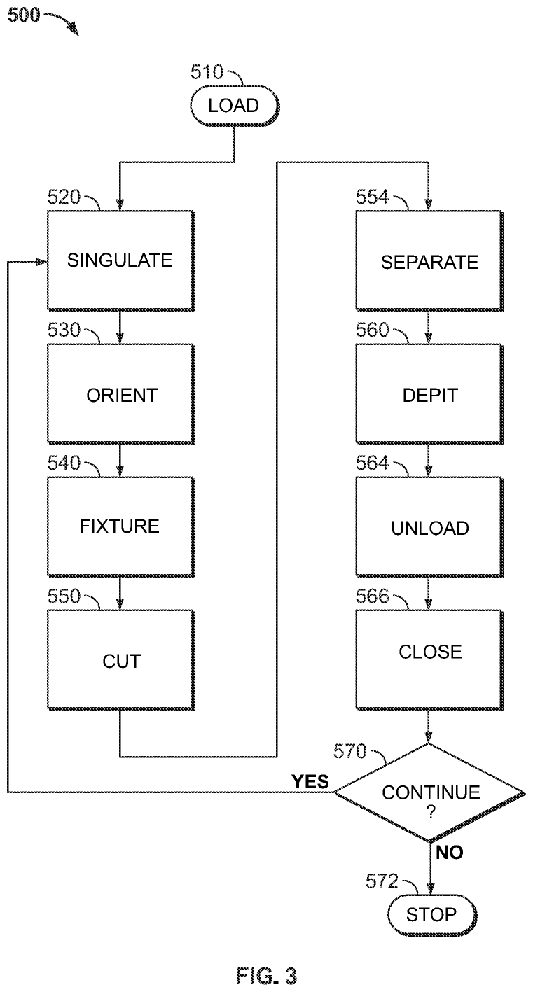

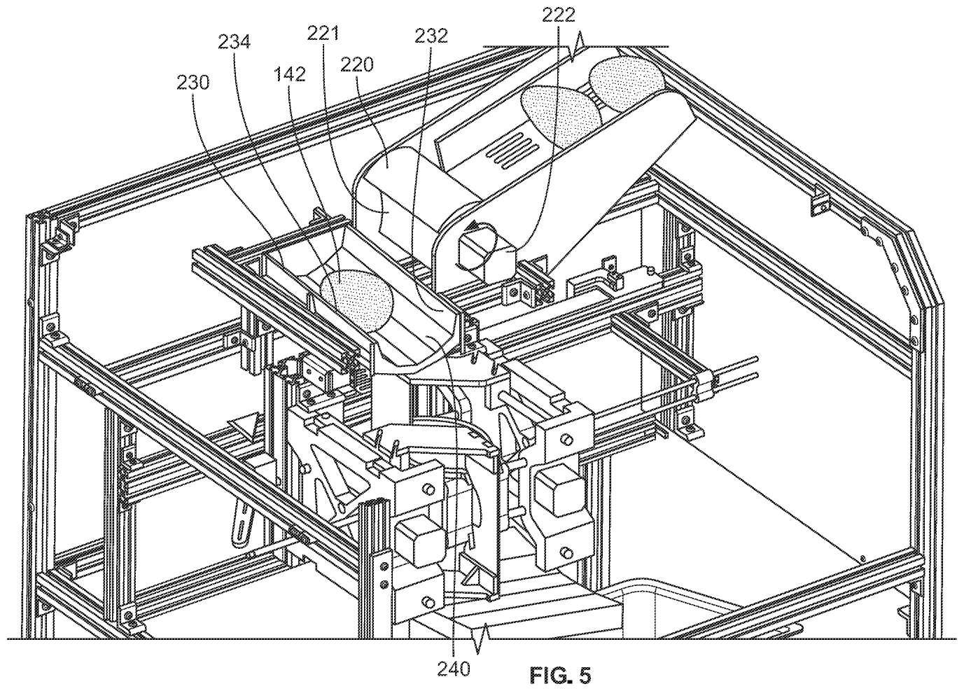

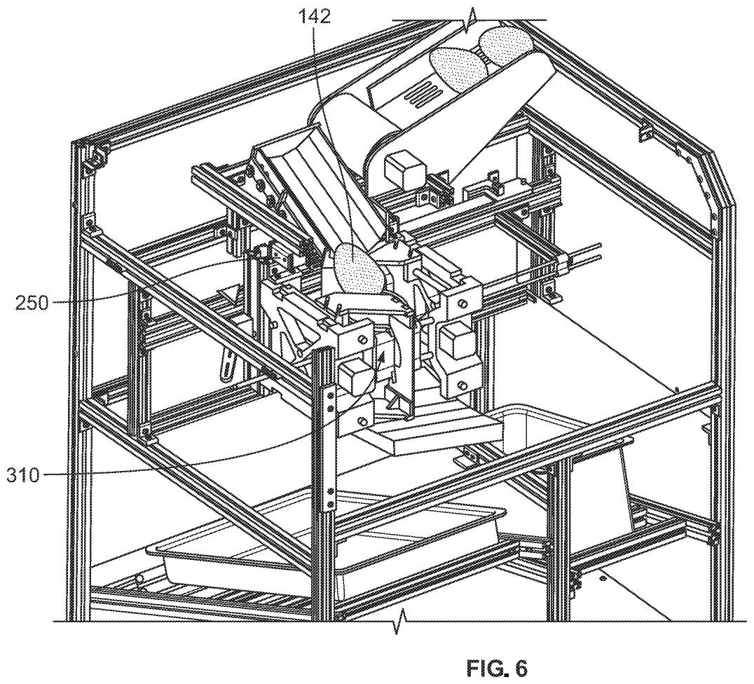

With reference to FIG. 3, a process 500 for splitting and removing the pit from an avocado is illustrated. In describing the process 500, reference is also made to FIGS. 5-14 for showing various exemplary structures to perform each of the steps of the avocado splitting process.

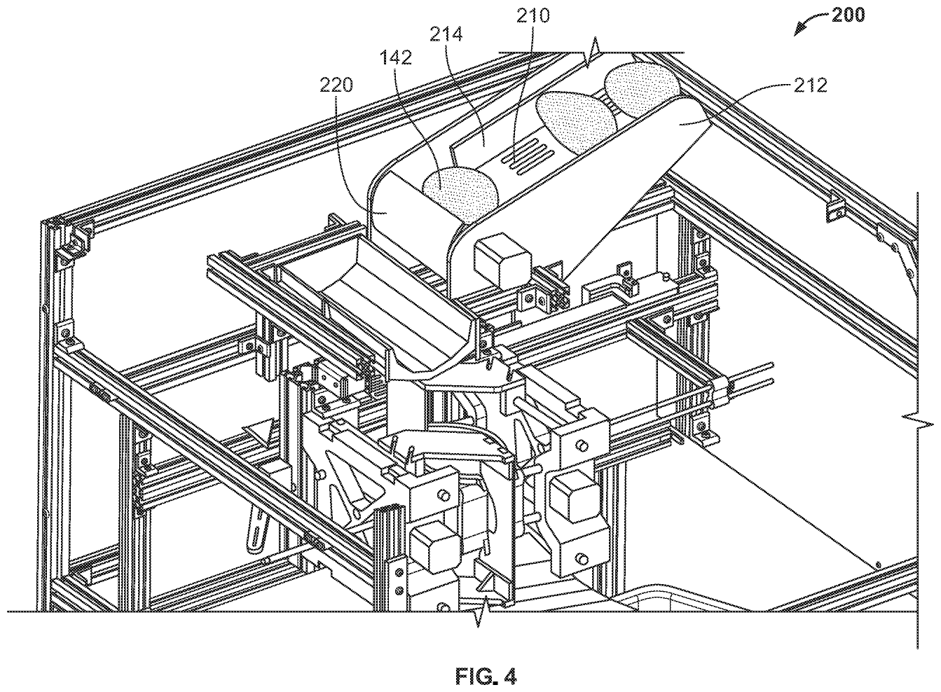

Step 510 states to load, namely, load one or more avocados into the hopper or loading assembly 200 shown in FIGS. 4-6. In the exemplary embodiment shown in FIGS. 4-6, this step is performed by placing avocados 142 on downward sloping guide 210 of hopper. Walls 212, 214 serve to direct the avocados in a single file along guide 210.

Optionally, wall 214 may be adjusted to accommodate different size batches of avocados. For example, if a batch is comprised of large avocados, wall 214 is adjusted to create the channel 210 for large avocados. A knob or button on the dashboard can be set to indicate the avocado size. This size information can also be used as input information in the cutting process, described herein.

Step 520 states to singulate. In embodiments of the invention, drum 220 is operable to capture one avocado at a time using cutout 221. The drum 220 is controllably rotated via a motor 222 to capture one avocado and deliver it to chute 230.

Step 530 states to orientate, namely, orientate the avocado 142. To perform this step, chute 230 includes opposing side walls 230, 232 and a curved floor 240 which collectively maintain the orientation of the avocado with the large end facing downwards. The tray is tiltable using, for example, motor 250. The tray is sufficiently tiltable to move between a home substantially horizontal position to an angled/sloped position which serves to eject the avocado 142 from the tray (large end first) and into cutting fixture 310. Optionally, a sensor is arranged to detect when the avocado hits the chute, or when the drum has rotated a sufficient angle. The sensor input is provided to a controller which is programmed to actuate the chute, namely, tilt the chute based on the input from the sensor. The types of sensors used in the system may vary. Exemplary sensors include limit switches as well proximity sensors.

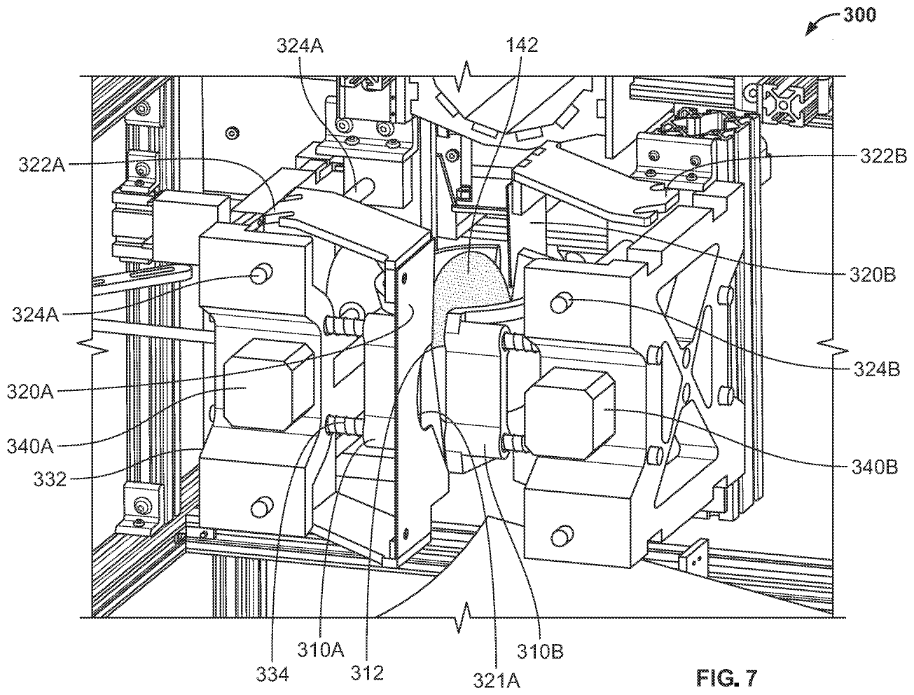

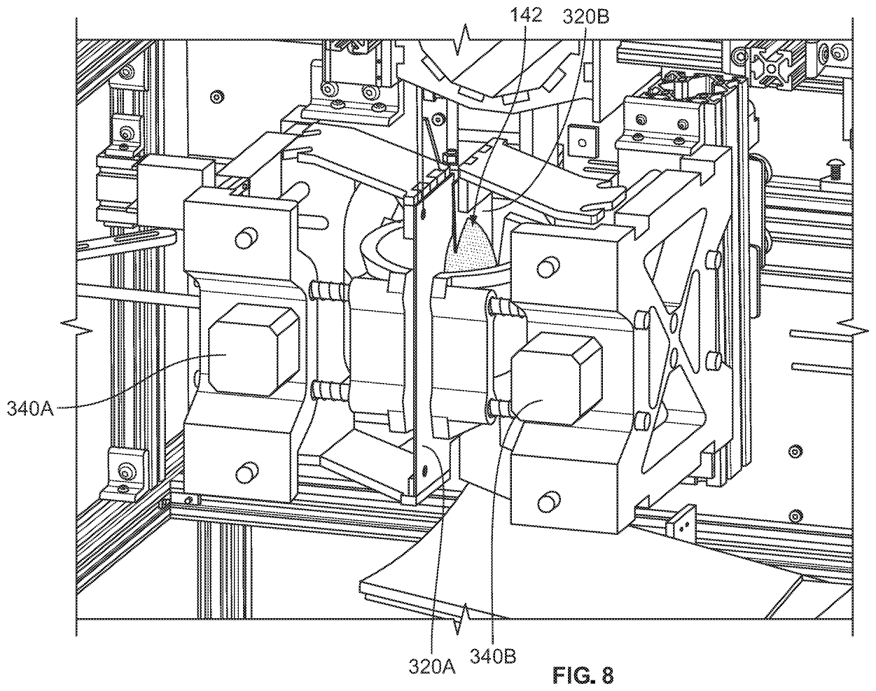

Step 540 states fixture. In the embodiment shown in FIGS. 7-8, the avocado is shown maintained or clamped between spring-loaded fixture halves 310A, 310B. The fixture halves 310A, 310B collectively form an avocado-shaped cavity. Optionally, the size of cavity is based on user input such as, for example, small, medium or large manually adjusted settings on the dashboard.

Step 550 states cut. Cutting the avocado 142 can be performed using opposing blades 320A, 320B. The blades 320A, 320B, are closable by actuating carriages 322A, 322B using leads screws and pins 324A, 324B by motors 340A, 340B. The blades 320A, 320B are moved within a vertical plane through seam 312, and avocado 142, thereby slicing the avocado to the pit. The blades may contact the pit but generally do not bite into the pit due to a cut-out 321A present in each of the blades to accommodate the pit. Additionally, preferably, the vertically-disposed cutting plane is not through the median plane of the avocado. The cutting plane is preferably spaced laterally from the median plane to facilitate ejection of the pit, discussed herein. In embodiments, the cutting plane is spaced 5 to 15 mm from the median plane.

The timing of blades may vary. In embodiments, a sensor is arranged to detect an avocado passing into the clamping zone. An example of a suitable sensor for detecting the avocado is an IR sensor. A controller receives the signal from the IR sensor and starts motion of the cutting blades. The blades continue cutting until a limit switch is activated, at which point the controller halts the motion of the blades. Although a particular arrangement of sensors is described herein, the invention may vary and the number, type and position of the sensors may vary. The invention is only intended to be limited where recited in any appended claims.

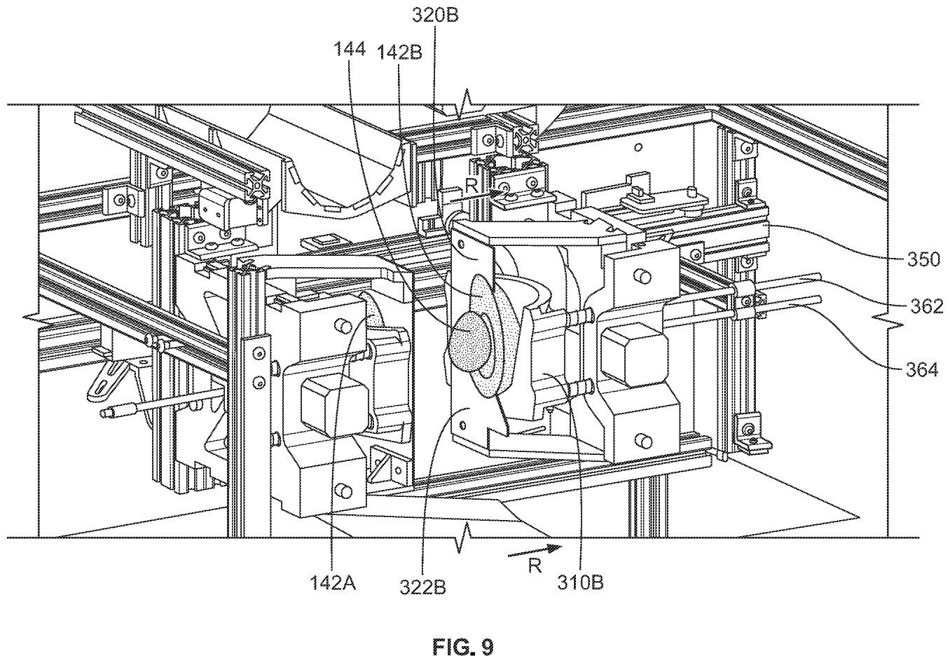

Step 554 states separate. That is, to separate the avocado halves 142A, 142B from one another. With reference to FIG. 9, cutting assembly half 310B is moved along track 350 in direction (R) away from the opposing cutting assembly, which is shown fixed. As the cutting assembly 310B continues to move rearward (R), the blade 320B remains in place to hold the avocado half 142B in place during movement.

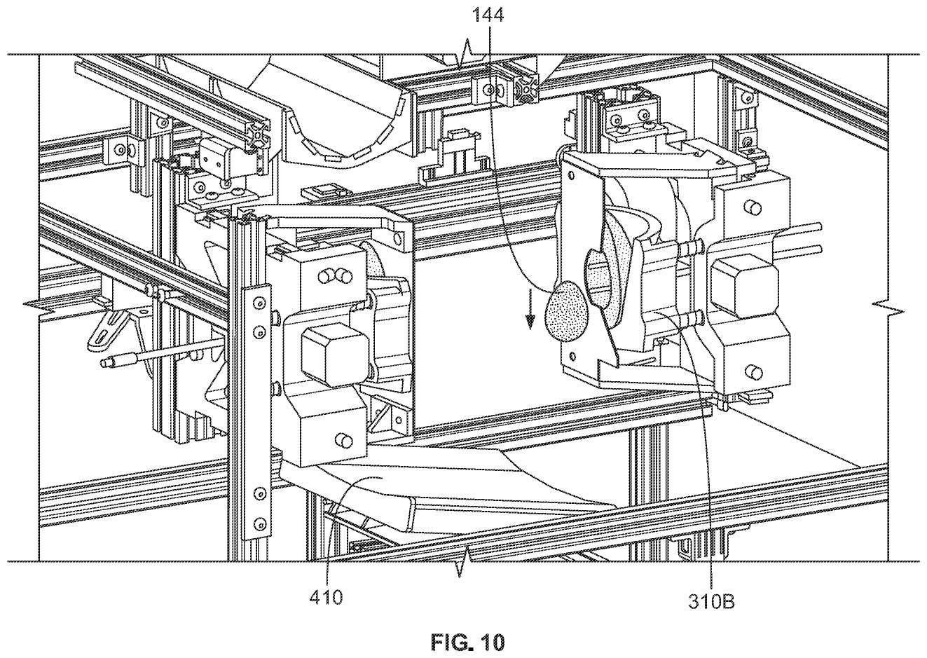

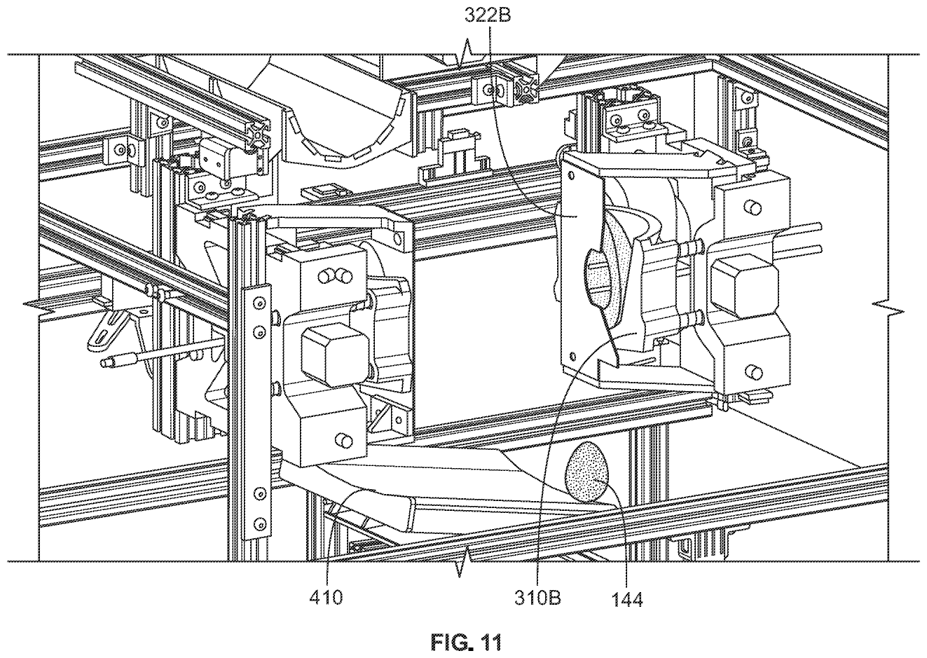

Step 560 states to depit. With reference again to FIG. 9, rods or pins 362, 364 are arranged relative to the cutting assembly to extend through openings in the fixture 310B and penetrate avocado half 142B. Further movement (R) of the cutting assembly causes the ends of pins to eject the pit 144 from the avocado half 142B through a pit-shaped cutout in the blade 320B. FIGS. 10-11 show the pit 144 falling to multipurpose ramp 410 and being directed into a waste bin (not shown). The carriage motion is halted once an outer limit switch is triggered.

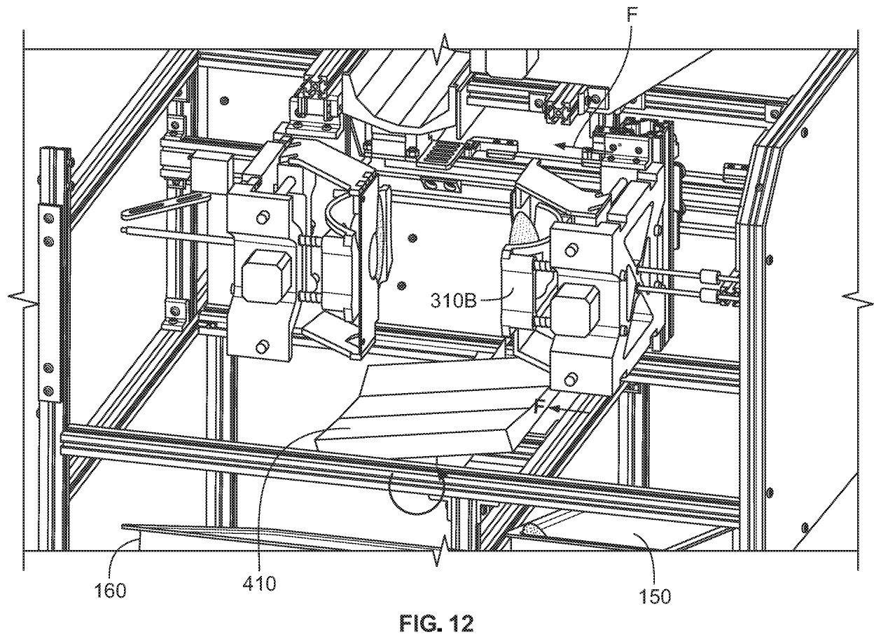

Step 564 states to unload. With reference to FIG. 12, cutting assembly 310B is shown moving in direction (F) towards the opposing fixed cutting assembly. The motion detaches the avocado half 142B from the pins used to eject the pit. However, the blade holds the avocado half in place.

Multipurpose ramp 410 (avocado slide) is also shown rotating counterclockwise at this time.

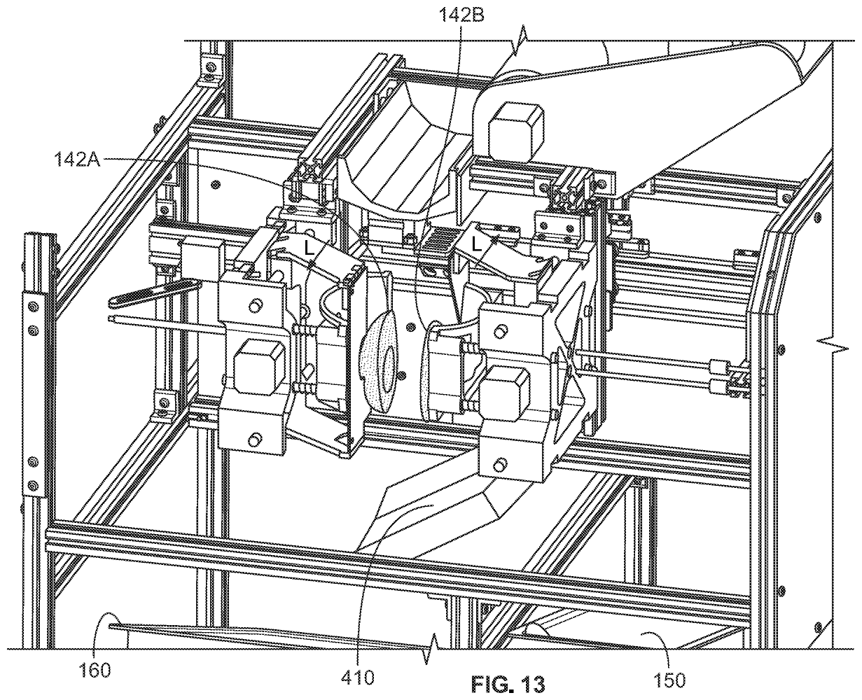

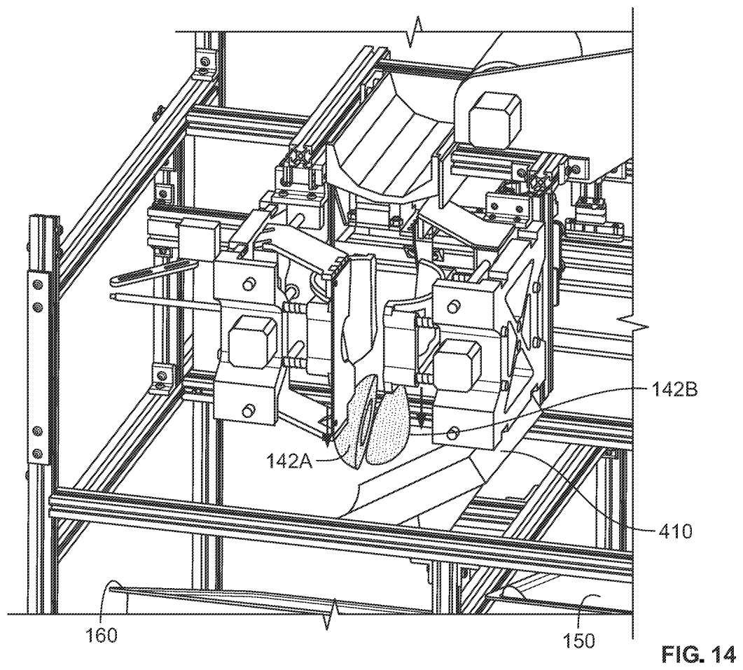

With reference to FIGS. 13-14, once the fixture 310B hits a middle limit switch, the controller starts blades moving in direction (L) or laterally. Consequently, avocado halves 142A, 142B are free to fall from the cavities. The blades continue to move outwardly until an outer blade limit switch is triggered.

Each avocado half 142A, 142B is shown falling towards multipurpose slide 410 in FIG. 14. The multipurpose slide is now aimed towards tray 160 instead of waste bin 150.

Optionally, a sensor is arranged to detect each avocado added tray 160. The information is sent to the processor which computes or updates the number of the avocados collected. In this manner, the system can compute metrics including number of avocados, estimated wright, time, size, name or ID, etc. Metrics and information may be stored and or sent via the computer to a display, described further herein.

Step 566 states close. Following unloading, the cutting assemblies, chutes, slides, and ramps return home (e.g., as shown in FIGS. 4-5) for repeating the process. Optionally, in the event the avocado size has been input or detected, the cutting assemblies and avocado cavity is adjusted based on the avocado size.

Step 570 queries whether to continue to cut and depit more avocadoes. If more avocados are present in the loading chute, the method returns to step 510 to singulate the next avocado. If avocados are not present, or is otherwise determined to stop, the process is terminated. Power is turned off.

In embodiments, the method and system are operable such that the total time between loading an avocado, splitting and removing the pit, and depositing the avocado halves into the tray is less than 10 seconds, and in some embodiments, less than 6 seconds.

Block and Sensor Diagram.

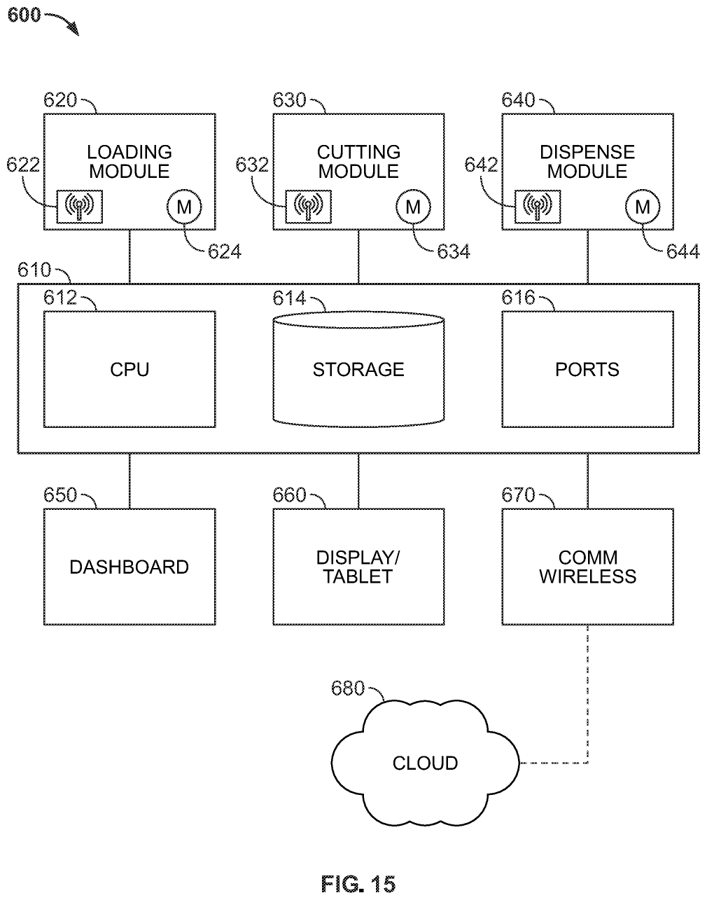

FIG. 15 is a block diagram of an avocado splitting and depitting system 600 in accordance with embodiments of the invention. The system 600 is shown including a computer 610, loading module 620, cutting module 630, dispensing module 640, and dashboard 650. Computer 610 is shown including a processor 612, storage 614, and ports 616 (or pins in the case of the micro-controller or PLC) for connecting with various different types of peripherals, devices and/or power. The computer may include one or more processors or a processor framework. The processor is programmed and operable to carry out the steps described herein based on firmware and software stored in the computer.

In the system 600 shown in FIG. 15, each of loading module 620, cutting module 630, and dispensing module 640 includes one or more dedicated sensors 622, 632, 642 and motors 624, 634, and 644. Modules are in communication with computer 610 which includes software to operate and keep track of the state of the motors and components as described herein.

Power supplies, converters, and other electronic components can be present for carrying out the steps described herein. Some components can be dedicated to one action or module, and other components can be shared. For example, the computer may include a DC power supply to drive each of the motors of the modules. Alternatively, each module may have a dedicated power supply. Indeed, the invention may include a wide range of electronic and mechanical (including pneumatic) configurations.

Optionally, the system 600 may include a display 660 such as monitor or a touchscreen tablet.

Optionally, the system may include a wireless communication board or module 670 for communicating with mobile devices, local networks, and/or remote servers or cloud servers 680.

Although a dashboard was described above including various buttons and switches, embodiments of the invention can include a screen and optionally, a touchscreen, to control the system. A computer may be programmed and operable to show or indicate (e.g., via animation) the status of the cutting process. The computer can be programmed and operable to keep statistics of the number avocados processed, namely, split and depitted, or otherwise processed as described herein. Estimates may be based on various operations of the system such as the number of times the blades close/open. In embodiments, a scale may be incorporated into the system to measure the weight of the fruits in the bin over time. In other embodiments, motions, timing and metrics can be controlled and detected using computer vision.

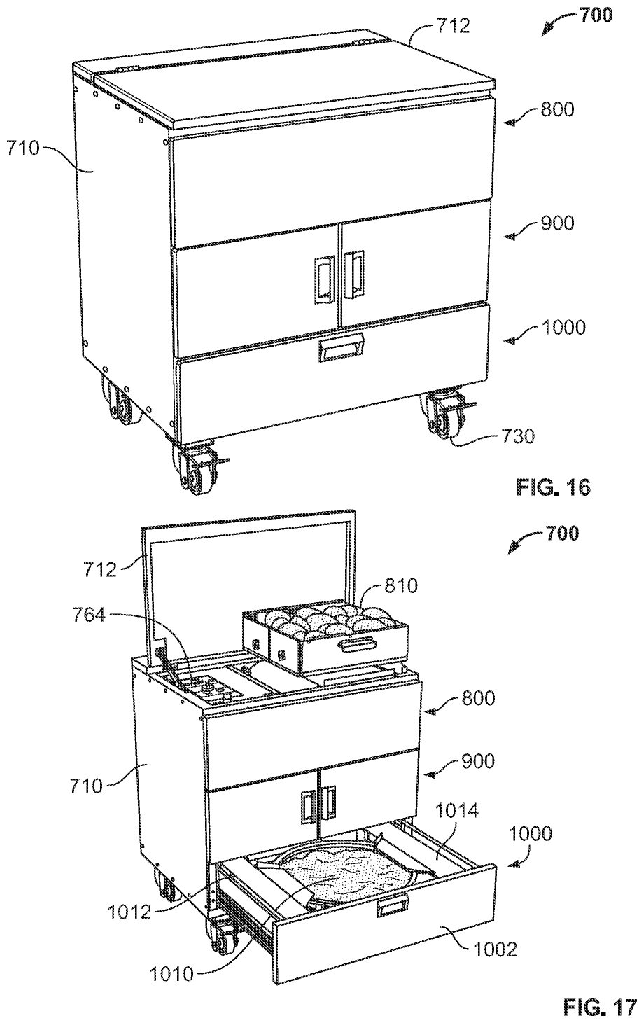

FIG. 16 shows another automated avocado splitting system 700 in accordance with an embodiment of the invention. The system 700 has an enclosure 710 including a pivotable lid 712. When the system is not processing avocadoes, the lid 712 can serve as a work surface. Castor wheels 730 are arranged on the feet of the frame to conveniently roll the entire system.

Similar to the system 100 described above, system 700 includes a loading assembly 800, a cutting and depitting assembly 900, and a food and waste storage 1000. However, the system 700 additionally includes a peeling assembly, described further herein, to extract the flesh from the peel of the avocado halves after the pit has been removed.

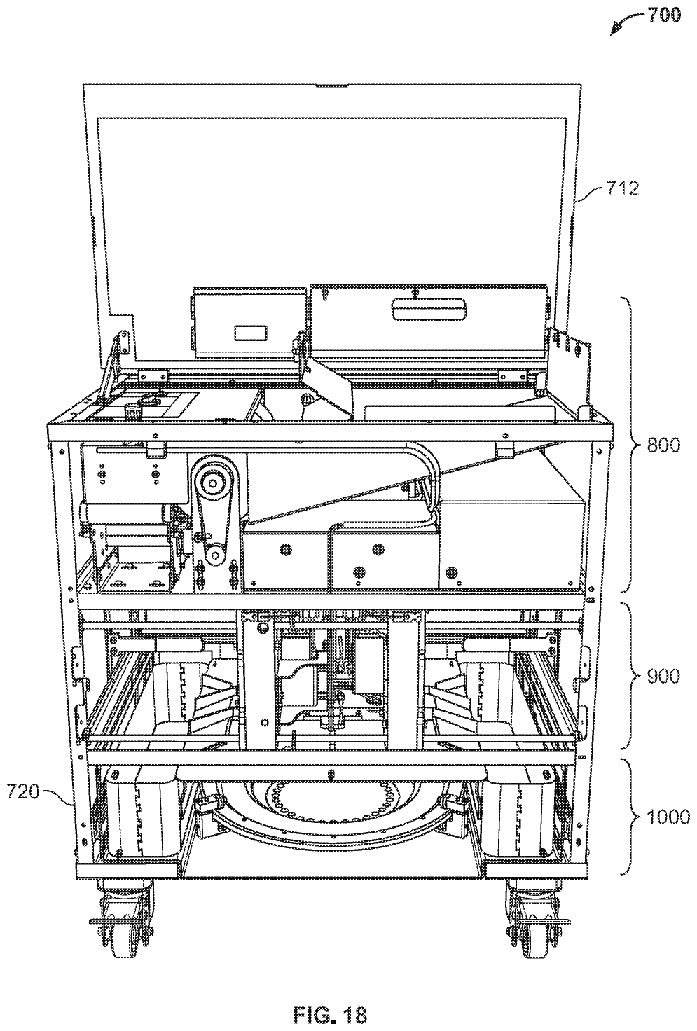

FIG. 17 shows the system 700 in another configuration in accordance with embodiments of the invention. The lid 712 is open and a hopper 810 is shown in an expanded configuration operable to hold multiple avocados, and in embodiments, up to a whole case of avocados. A dashboard 764 is shown on the top of the body 710 including a power switch, emergency stop and various other buttons, lights, indicators, gauges for controlling operations of the system as described further herein.

FIG. 17 also shows slidable drawer 1002 in an extended position. The drawer 1002 is operable to hold a food storage bowl 1010 and waste bins 1012, 1014. In the embodiment shown in FIG. 17, the bowl catches and holds the avocado flesh, and the bins hold the pits and skins, discussed further herein.

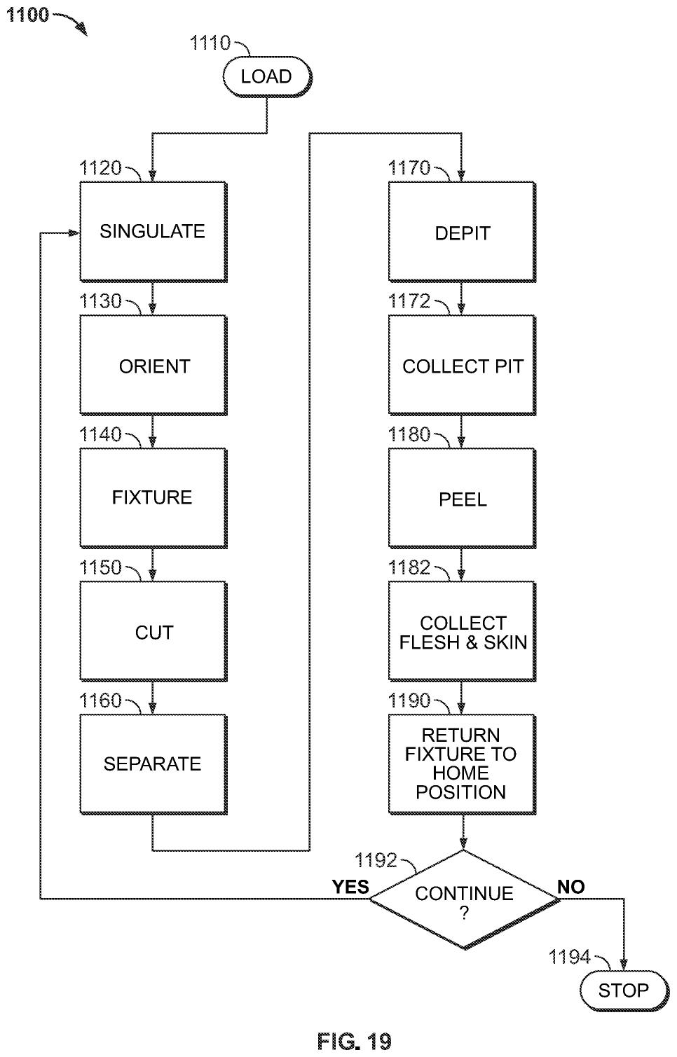

FIG. 18 is a front top perspective view of the avocado processing system 700 shown in FIG. 16 with the enclosure removed for facilitating understanding of the invention. Particularly, FIG. 18 illustrates the relative internal arrangement of loading assembly 800, an integrated cutting, coring, and peeling assembly 900, and food and waste holding assembly 1000, all mounted on frame 720.

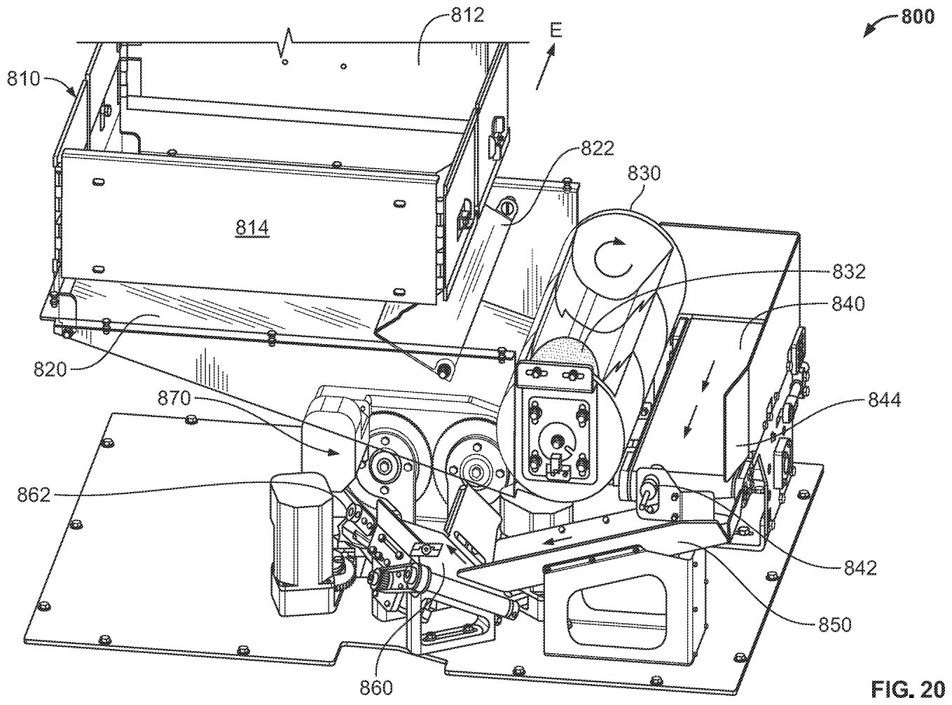

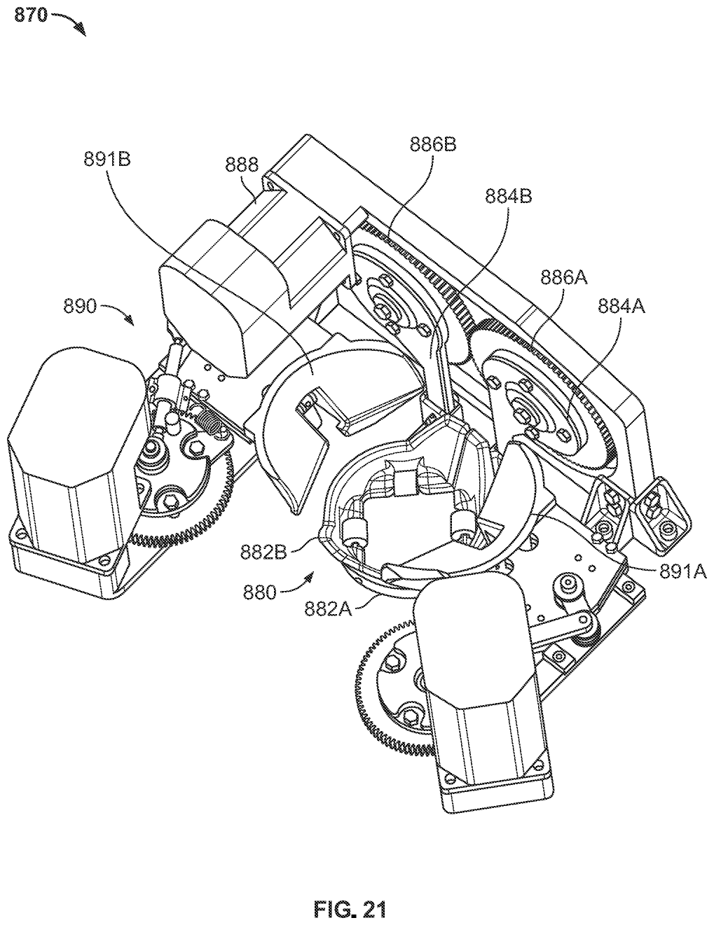

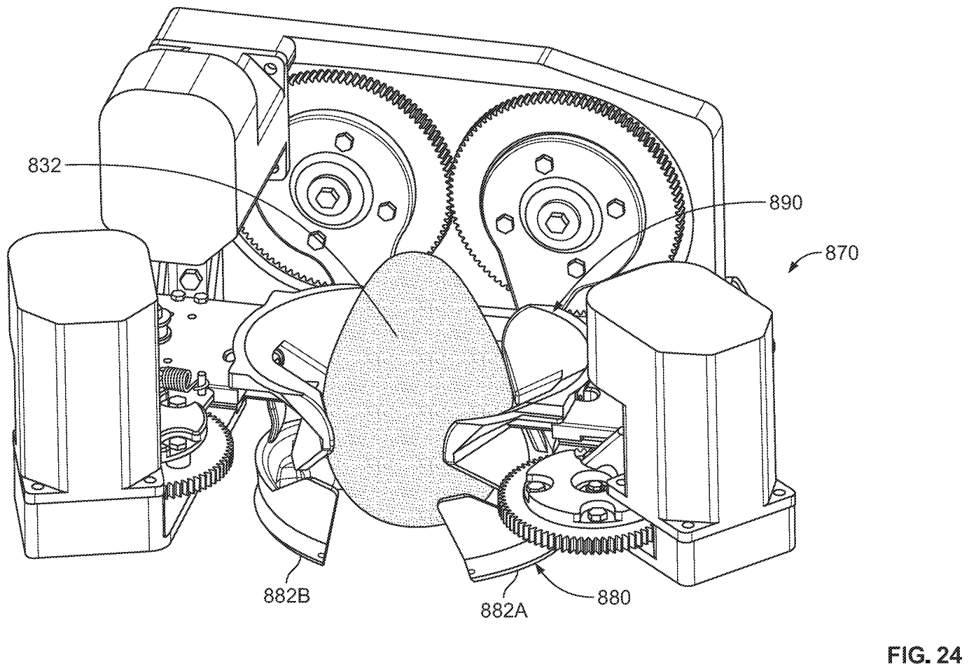

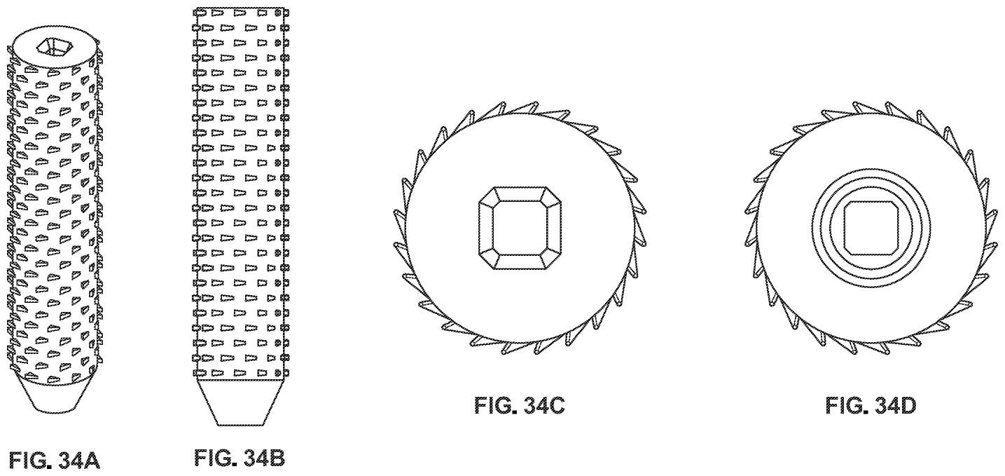

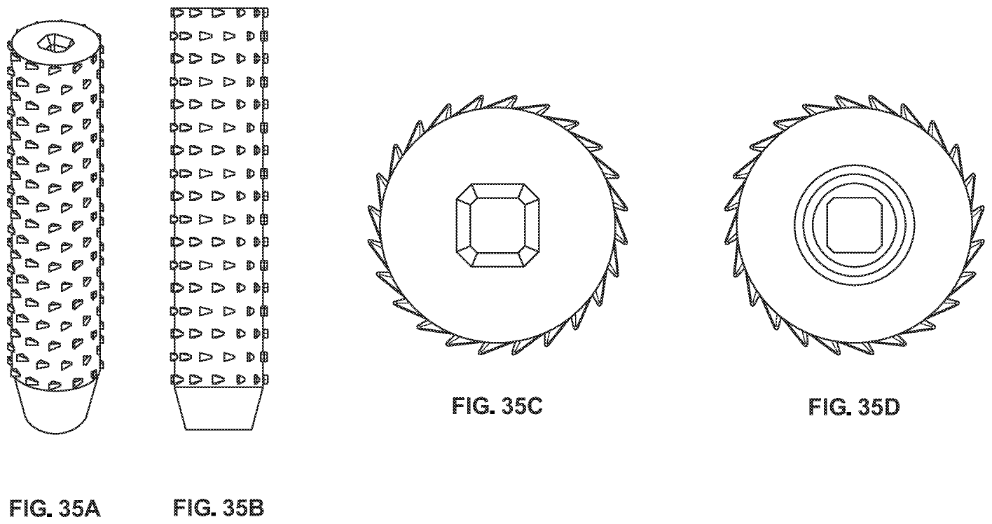

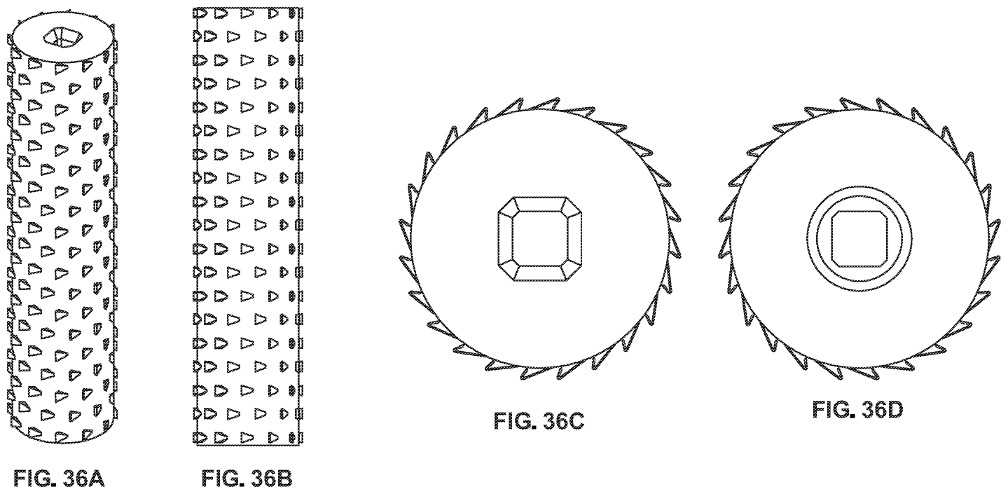

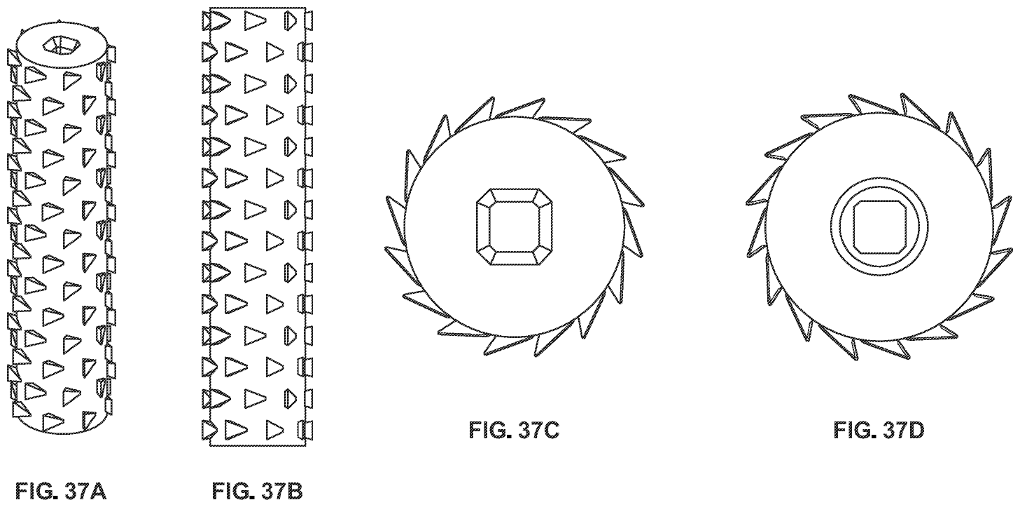

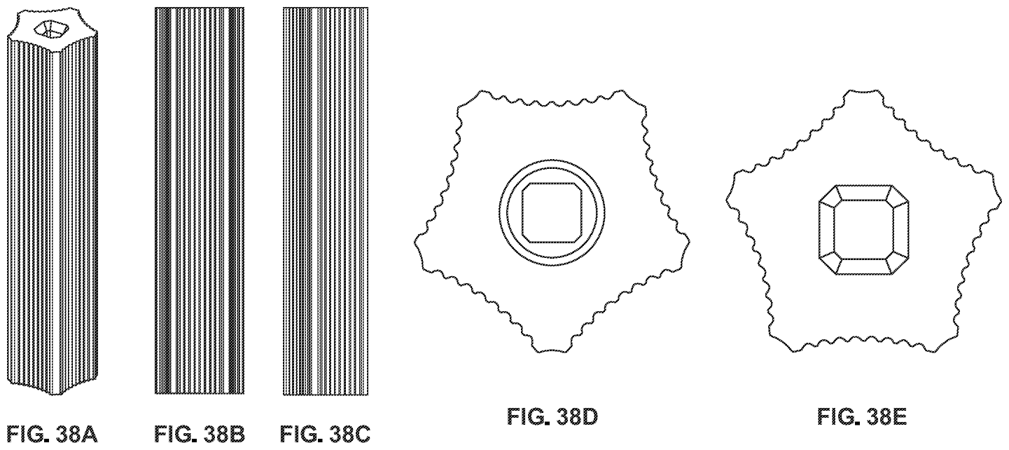

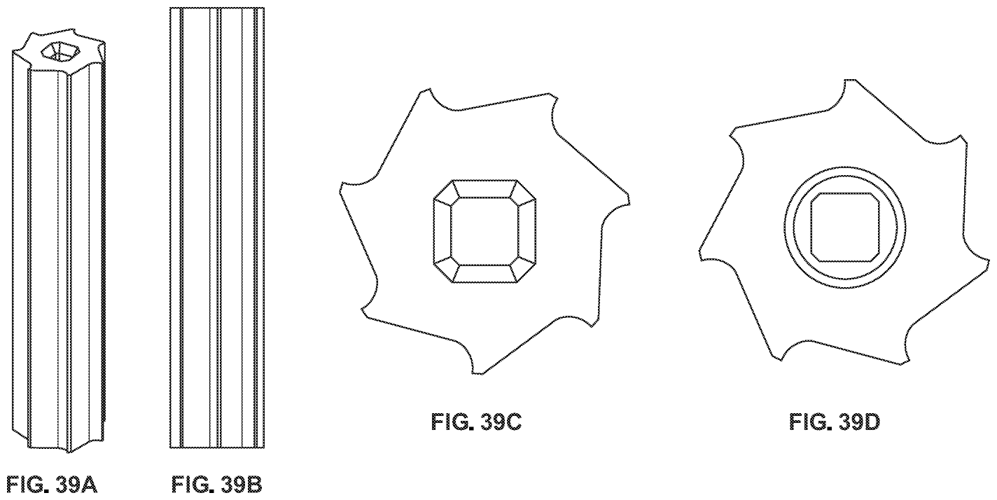

With reference to FIG. 19, an exemplary process 1100 for splitting, depitting, and peeling an avocado is illustrated. In describing the process 1100, reference is also made to FIGS. 20-44 for showing various exemplary structures to perform each of the steps of the process.

Hopper

Step 1110 states to load. With reference to FIG. 20, this step may be carried out by placing one or more avocados in hopper 810 of the loading assembly 800. The hopper 810 is operable to store a full case capacity of avocados. Optionally, walls 812 of the hopper are operable to unfold and be extended laterally (E) from the reference wall 814. Consequently, the hopper can accommodate more volume, namely, more fruit and vegetables, within the same machine footprint.

Singulate

Step 1120 states to singulate, namely, singulate one avocado from the batch of avocados. This step can also be carried out by the loading assembly 800.

Avocados from the hopper 810 are fed by gravity down ramp 820. Optionally, a deflector 822 is spaced from the ramp to arrange the avocados into one layer as the avocados descend the ramp.

A loading mechanism such as rotating drum 830 is shown at the base of the ramp to pick up the avocados and dispense them onto the single-file conveyor 840. The rotating drum is shown having an elongate cut-out adapted to carry one or more avocados from the ramp 820 to single-file path 840. The drum also serves to meter or limit the number of avocados to the path 840. In a sense, the drum acts as a flow control mechanism.

The conveyor 840 is controlled to dispense one avocado at a time to a chute 850. The chute shown in FIG. 20 has a V-shape, to help transfer the avocado lengthwise along the path of travel, and is slanted downwards to gravity feed an avocado to a tilted conveyor 860.

Tilted conveyor 860 moves the single avocado towards the ‘hand off’ location, while continuing to maintain the avocado lengthwise across its travel, for the next phase in the process, namely, orientation assembly 870, discussed herein.

In embodiments of the invention, a sensor suite comprising a plurality of sensors is arranged along the path of travel or route to singulate an avocado. In the embodiment shown in FIG. 20, for example, a first sensor 842 scans for the presence of an avocado on conveyor 840 and triggers a mechanism (e.g., electric conveyor motor) to continue advancing the dispensed avocados on conveyor 840 or trigger the metering mechanism (e.g., the drum) to dispense more avocados.

A second sensor 844 is located at a handoff point such as the end of the conveyor 840. Second sensor 844 detects the avocado at the end of the conveyor 840 which continues to run until the avocado is no longer detected, confirming the avocado has been delivered downstream.

A third sensor 862 is arranged downstream and confirms that the avocado has translated from the second sensor location to the end of the route of the hopper/loading area. Once the third sensor 862 confirms the avocado has reached the end of the route of the loading stage, the handoff to the next stage (namely, orientation assembly 870) is triggered, discussed herein.

Once the final handoff to the orientating stage is completed, the third sensor 862 further confirms an avocado is not present at the end destination and restarts the conveyor 840 to move the next avocado onto chute 850.

Optionally, the first two sensors could provide information about the location of the avocado along its path of travel.

Optionally, in lieu of sensors, other mechanisms (mechanical-based) can be arranged along the route to singulate an avocado including, e.g., levers or switches along the route that are triggered when an avocado passes. The levers and switches may be designed to cause the conveyor motors to start and stop. Indeed, a wide range of trigger arrangements to control dispensing and singulation of an avocado are intended to be included within the scope of the invention.

Orientation

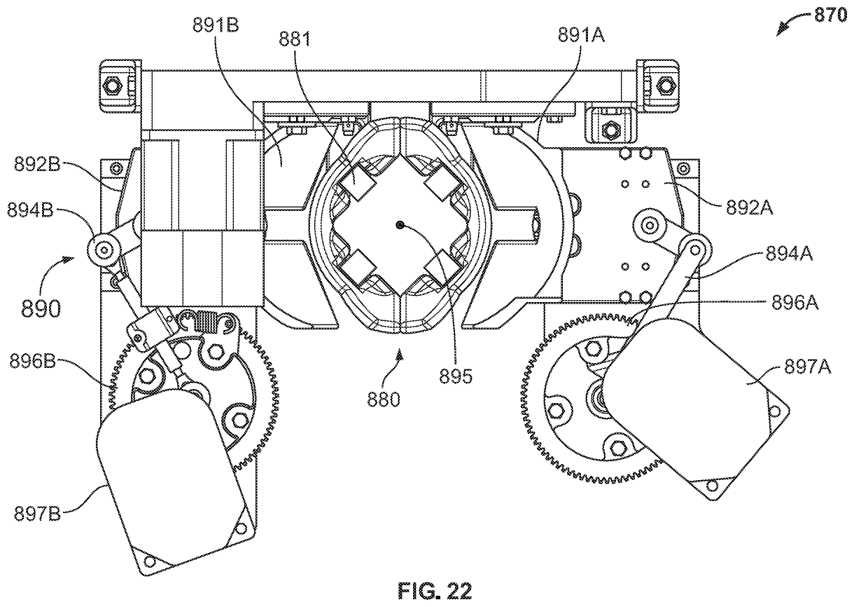

Step 1130 states to orient the avocado. In embodiments, this step is performed by an orienting assembly as shown in FIGS. 21-24. As described herein the assembly 870 is operable to optimally orient various sized avocados prior to transferring (namely, handing off) the avocado to the next stage.

The orientation assembly 870 is shown including a release mechanism 880 and an orientation mechanism 890. The release mechanism is arranged directly above the handoff location for dropping the avocado in proper orientation into the fixture tool for cutting the avocado in halves, discussed herein.

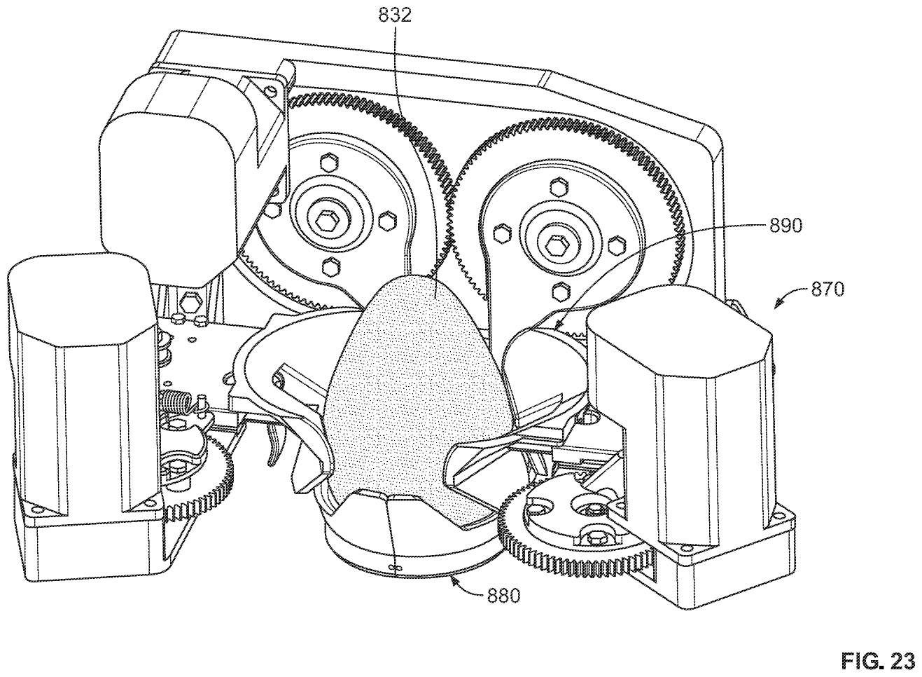

In the embodiment shown in FIGS. 21-22, the release mechanism 880 includes clamshell holds 882A, 882B that are mechanically linked (via arms 884A/B and gears 886A/B) such that they can move equally in opposing directions when driven by an actuator 888.

With reference to FIGS. 21-23, the clamshell is shown in a fully closed position with the two sides meeting in the middle. Each clamshell hold 882A/B is shown having two rollers 881 arranged to make contact tangent to the object when the clamshell holds are in the closed configuration. The rollers 881 allow the object to be freely oriented with minimal friction. As the clamshell moves from the closed to open configuration, the object falls through the opening and the rollers apply a tangential force that aligns the object vertically along its major axis. For example, when the object is an avocado, the main axis encompassing the avocado stem is aligned vertically.

In embodiments, the release mechanism 880 is operable to include a discrete number of open positions tuned to the size of the object being dropped. Examples of sizes that the release mechanism can be tuned range from 40 mm to 100 mm in diameter. The shape, size and number of rollers may also vary as well as the size range given a larger or smaller mechanism of similar proportions

The orientation assembly 870 shown in FIGS. 21-24 also includes a guiding mechanism 890. Guiding mechanism 890 includes a set of opposing funnel halves 891A/B to stage the avocado to land vertically in the clamshell holds 880. The funnels halves 891A/B are actuated by a series of gears 896A/B, links 894A/B, supports 892A/B, and motors 897A/B such that the size of the aperture that the object passes through is dynamic. The aperture size can be tuned based on the size of the avocados to accurately place the avocado in the clamshell holds.

Additionally, one or more sensors may be incorporated in the orientation assembly 870 to detect the presence of, measure distance, measure angle, and count the objects. For example, in embodiments and with reference to FIG. 22, the center 895 of the aperture of clamshell holds can be sensed for an object. The sensor (not shown) may be mounted above the aperture by a support.

The hardware and electronics may vary. Examples of types of sensors include without limitation time of flight sensors, ultrasonic sensors, retro-reflective sensors & photoelectric sensors. Examples of types of actuators include without limitation stepper motors & servomotors.

Cutting

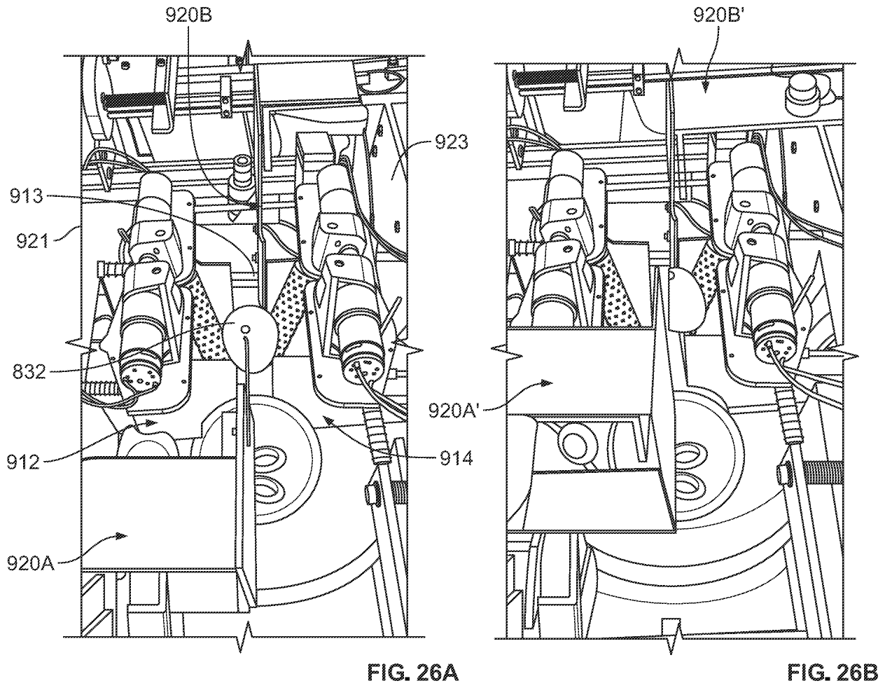

Steps 1140 and 1150 state to fixture and cut, respectively. In embodiments, and with reference to FIG. 25, this step is performed by catching the avocado 832 from the orienting assembly in an object capture zone of a fixture or clamping assembly 910. In the embodiment shown in FIG. 25, the clamping assembly comprises opposing clamping tools 912, 914. The clamping tools 912,914 are shown as cylindrical elongate members and comprise a roughened or textured surface to facilitate gripping the object. The clamping tools are collectively operable to apply force to the avocado to hold it in place during cutting, described herein.

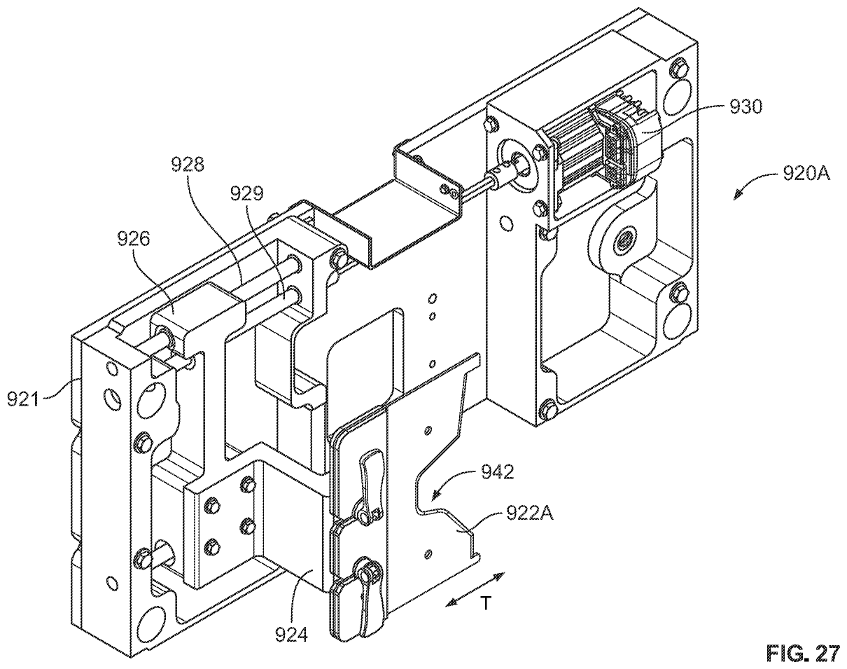

Next, the avocado 832 is cut. This step may be performed, with reference to FIGS. 26A-26B, by advancing opposing blade assemblies from a retracted configuration 920A, 920B through the seam 913 in the clamping tools to the extended/actuated configuration 920A′, 920B′.

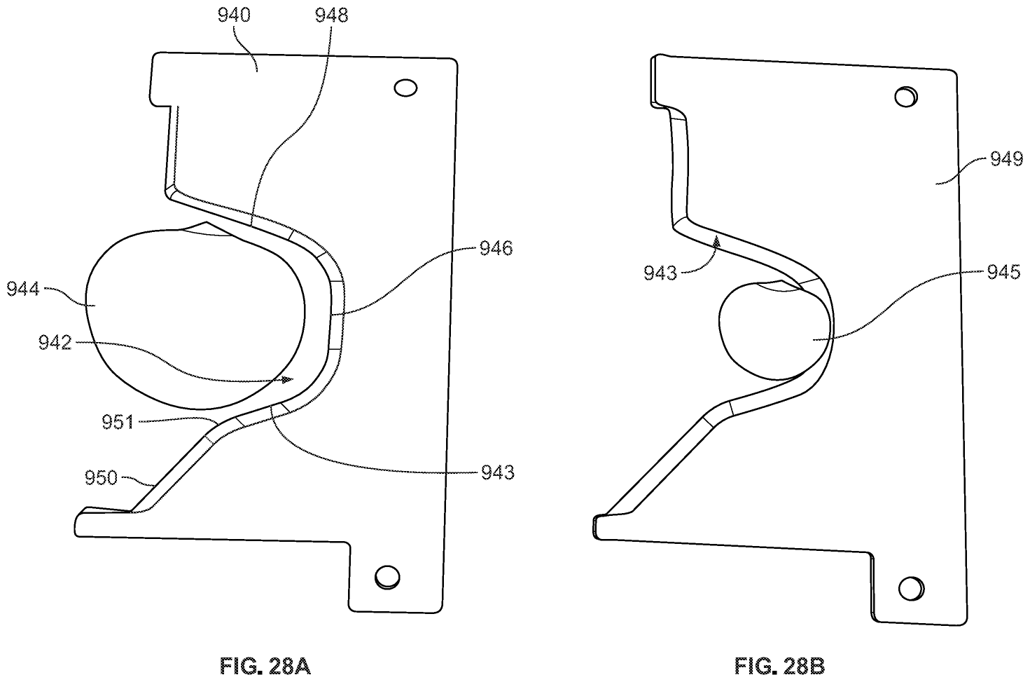

The cutting assemblies may vary. In an embodiment, and with reference to FIG. 27, a cutting blade 922A is mounted to a blade carriage 926 via arm 924, and movable in the transverse direction (T). Blade carriage 926 is shown supported by rail 928 and lead screw 929. Lead screw is driven by motor 930, all of which are shown mounted to peeling carriage 921.

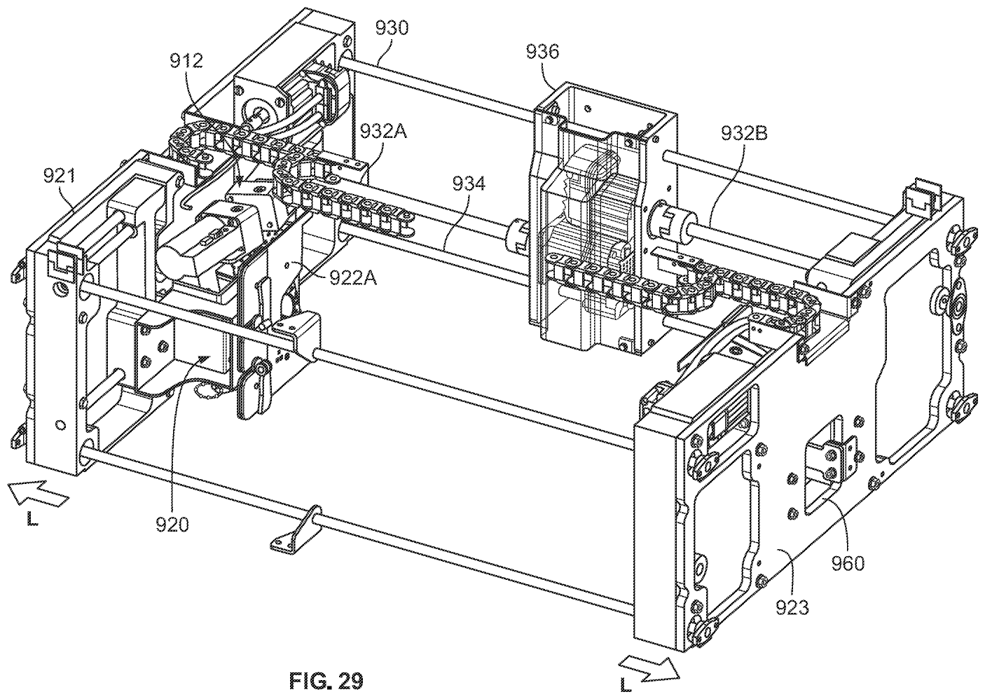

FIGS. 28A-28B are side views of cutting blades 940, 949 shaped to accommodate a large 944 and small pit 945, respectively, in accordance with an embodiment of the invention. Blade 940 includes a cutout 942 shaped to cut around the pit of an avocado. Although the cutout may have a generally semicircular or bowl-shape, in embodiments, each cutout includes several discrete zones including top 948, main 946, and bottom 943 collectively forming a concave region. The length of the main zone can range from 25 mm to 50 mm. The top zone forms an angle with the main zone ranging from 90 to 110 degrees, and has a length ranging from 20 to 40 mm.

Preferably, the blade includes a sloped or convex lower zone 950 to direct the seed or pit into the cutout described above. The lower half of the blade incorporates an inflexion point 951 between the sloped, concave and convex curvatures of the cutout. In embodiments, the slope of the lower zone 950 ranges from 45 to 60 degrees. Inventors have found the shapes of the cutouts described herein serve to facilitate cutting and ejection of the pit.

Depitting

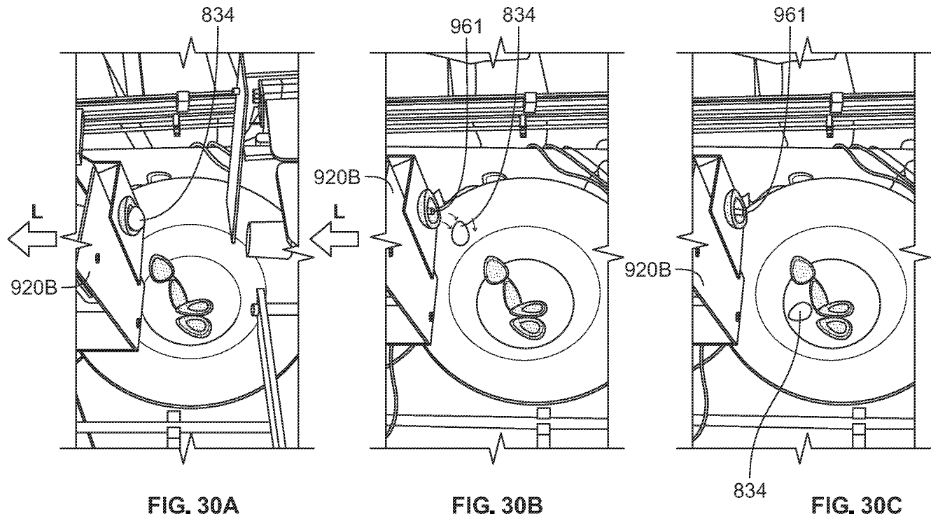

Steps 1160 and 1170 state to separate and depit, respectively. With reference to FIG. 29, and with the blades still penetrating the avocado, the peeling carriages 921, 923 are moved apart. Particularly, the peeling carriages 921, 923 are moved in the lateral (L) direction along rails 930, 934 by lead screws 932A, 932B and motors housed in compartment 936. Each peeling carriage 921, 923 holds an avocado half between its blade (e.g., 922A, 922B) and the peeling assembly (e.g., clamping tool 912, 914).

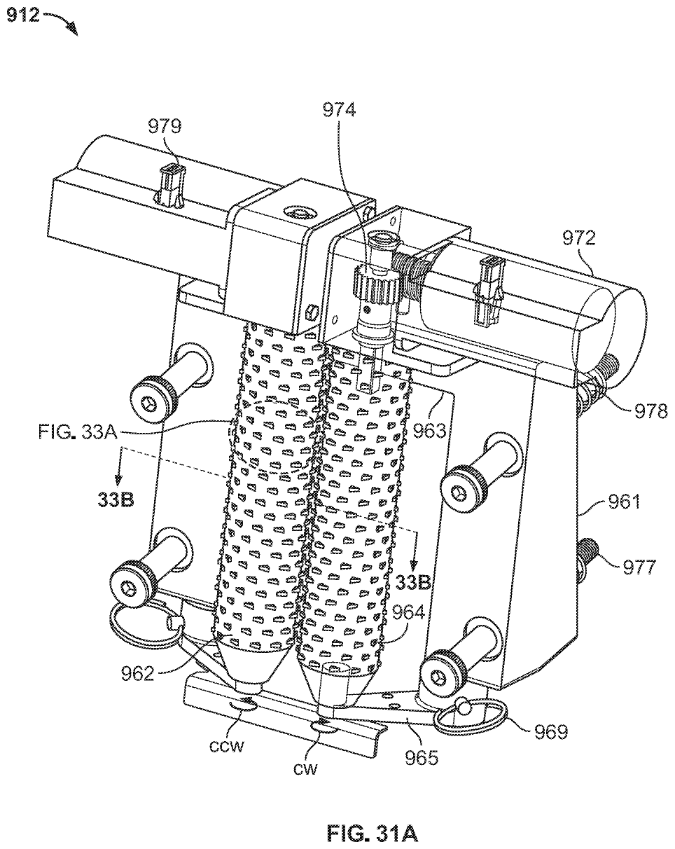

With reference to sequential illustrations shown in FIGS. 30A-30C, as the peeling carriage and blade assembly 920B are laterally moved (L), an elongate corer 961 extending through window 960 of the peeling assembly and blade assembly ejects the pit 834 from the avocado half similar to the process described above in connection with FIGS. 9-11. In preferred embodiments of the invention, a coring tool is arranged on both sides of the system to properly de-pit the avocado regardless of which split half holds the pit.

Step 1172 states to collect the pit. This step is performed automatically by directing the ejected pit into a waste container as described herein in connection with Step 1182 for collecting the flesh and skin of the avocado.

Peeling

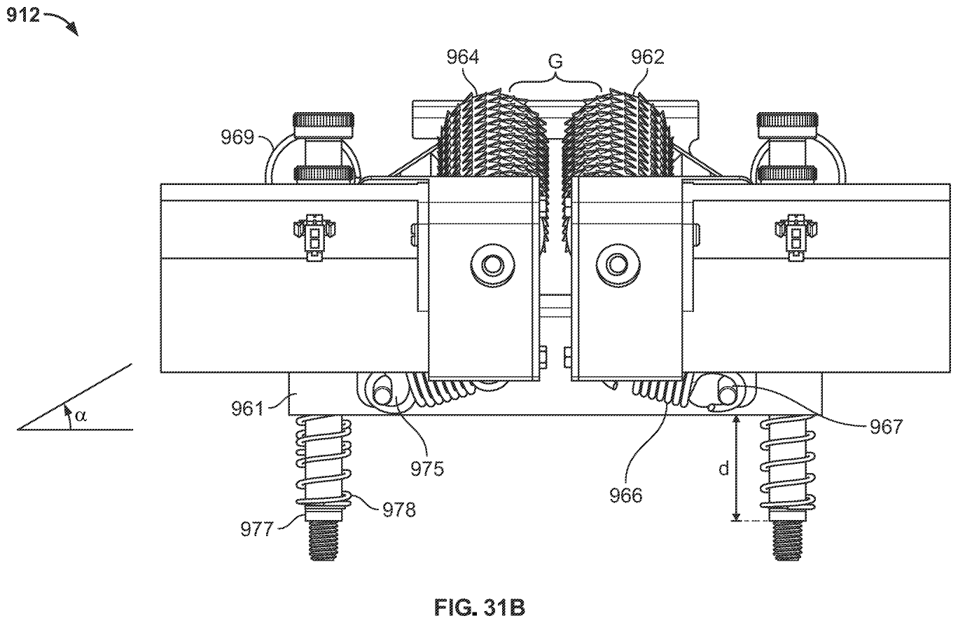

Step 1180 states peel, namely, to peel the skin from the avocado halves. With reference to FIGS. 31A-31B, peeling assembly 912 is shown with the cutting assembly removed for facilitating understanding of the invention.

Peeling assembly 912 includes a body 961 defining a window or opening 963. Two counter-rotating cylindrical-shaped peeling tools 962, 964 are arranged side by side in front of the window. Peeling tool 962 rotates counterclockwise (CCW) and peeling tool 964 rotates clockwise (CW) so as to draw in the skin when an avocado makes contact.

Each spinning tool 962, 964 is driven at its upper end by a motor (e.g., gear motor 972) and gear (e.g., worm gear 974). An electrical connector 979 is shown extending from each gear box. The base of each spinning tool is rotatably held by a roller support (e.g., arm 965). Mounting studs and a clamping guide 977 couple the peeling assembly body 961 to the laterally movable peeling carriage (e.g., the peeling carriage 921 shown in FIG. 29).

With reference to FIGS. 31B, 31C, and 31D, the spinning peeling tools 962, 964 are pivotably coupled to the body via a peeler pivot shaft 973 thereby allowing the tools to separate from one another and provide an adjustable gap (G). However, preferably, the spinning peeling tools 962, 964 are arranged to resist freely spreading. In embodiments, the range of motion of the peeling tools is limited by spring anchor 967. Anchor 967 acts as a stop. Further, a resilient or compliant mechanism (e.g., spring 966) urges the peeling tools 962, 964 towards the body 961, thereby providing squeezing pressure during the peeling process.

In embodiments of the invention, the gap (G) ranges from 5 to 15 mm. In embodiments of the invention, the angular range of motion of the peeling tool (alpha), is less than 20, and more preferably less than 10, and in preferred embodiments 5 to 10 degrees. In one embodiment alpha is between 8 and 9 degrees. In embodiments of the invention, the linear range of motion (d) of the peeling mechanism is less than 40 mm and more than 10 mm, and in preferred embodiments between 25 and 35 mm.

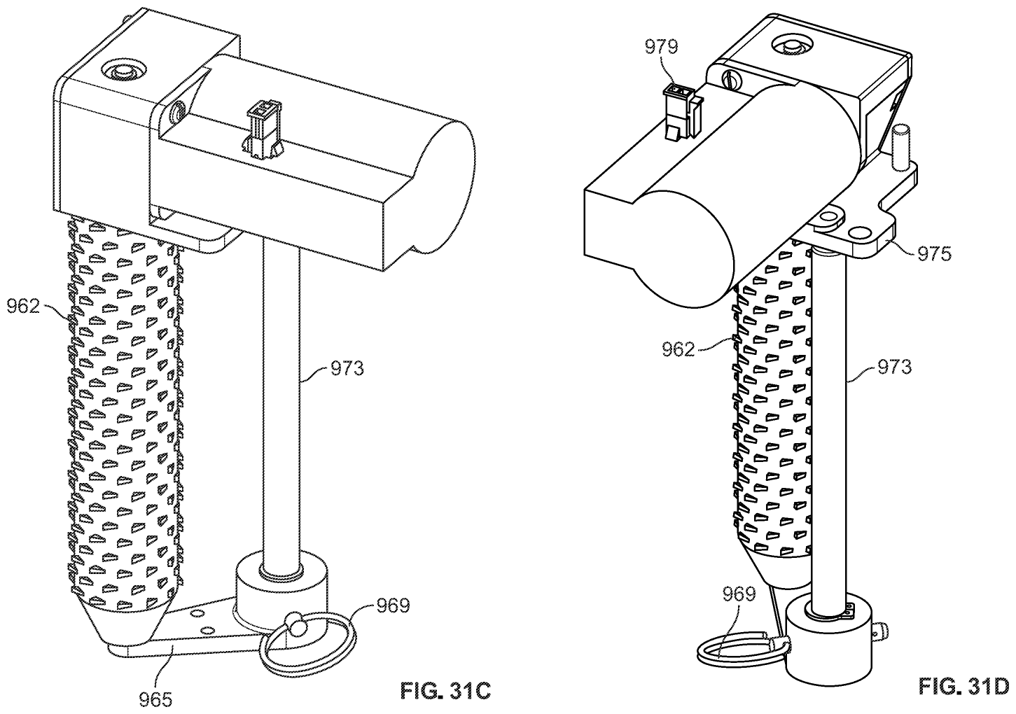

With reference to FIGS. 32A-32B, a halved and pitted avocado 980 is shown wedged between extended blade 982 and the peeling assembly 912. The structural arrangement of the cutting blade 982, peeling assembly 912, and additional clamping pressure arising from spring 966 (shown FIG. 31B) urges the skin side of the avocado half 980 into the rotating peeling tools (e.g., 962, 964). The rotation of the peeling tools pulls the produce 980 into the gap (G) between the tools. As the avocado is drawn into the gap, the compliant mechanism (e.g., spring 966) is deformed and consequently, applies a pinching force to the avocado by the opposing rotating peeling tools (e.g., 962, 964). The combination of the pulling from the rotating tools and the pinching force from the compliant mechanism shears the boundary between the skin 986 and flesh 984. As the skin 986 is further drawn into the gap between the rotating tools, any remaining bits of flesh stuck to the skin are squeezed out. Once the peeling is done, and the cutting blade is retracted 982′, the flesh 984 falls ahead of the peeling tools while the skin 986 falls behind. A window 963 in the body of the peeling assembly 912 provides space for the skin to fall through.

Roller Surface Details

In preferred embodiments, the surface of the rotating peeling tools is designed to maximize adherence with the skin of the produce. Non-limiting exemplary surface features include teeth, texture, protrusions, bumps, barbs, spines, grooves, ridges, and threads.

In preferred embodiments, the axial cross-sectional geometry of the rotating peeling tools may also be designed to maximize the pinching force that can be periodically generated between 2 counter rotating peeling tools. This is achieved with geometries of varying radius around the axis of rotation of the tools thus creating void zones on the tools where produce may easily sit in between 2 counter rotating tools followed by protruding zones which may apply high pinching pressure on the produce. Non-limiting exemplary geometries include squares, pentagons, hexagons, and circles, preferably offset from the axis of rotation of the tool

In preferred embodiments, the radial cross-sectional geometry of the rotating peeling tool may be designed to maximize the contact patch with the produce. For oblong produce, an hour-glass shaped tool may be employed to that effect.

In preferred embodiments, any combination of high adherence features, high pinch axial cross sections and high contact patch radial cross sections may be employed to maximize the peeling capability of the tool.

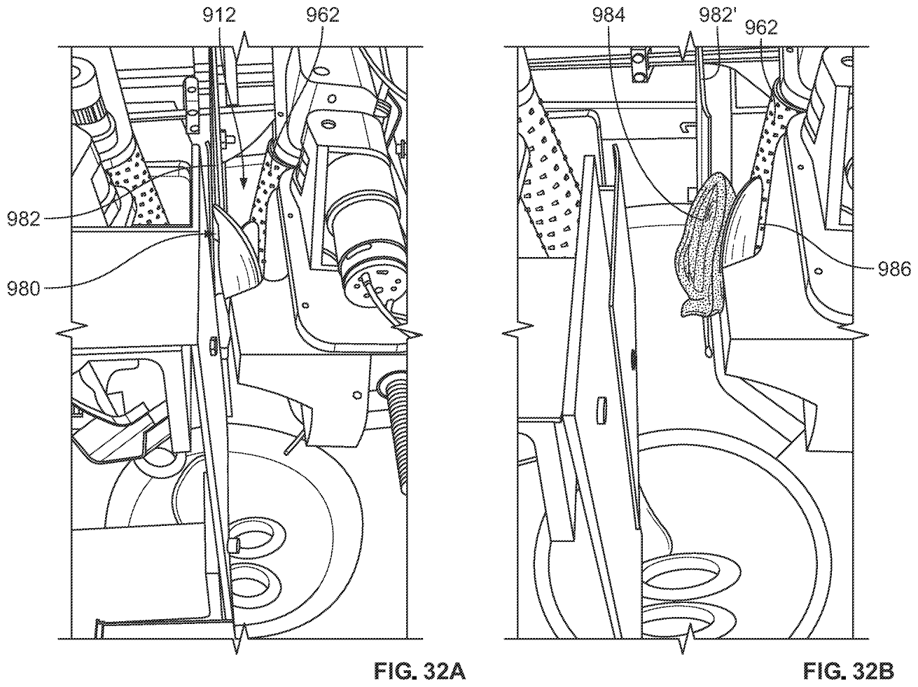

With reference to FIGS. 33A-33B, an exemplary surface geometry and roller cross section in accordance with an embodiment of the invention is illustrated. Particularly, a roller 962 comprises a circular cross section defined by a diameter (DIA) and the surface includes a plurality of identical teeth 999 arranged in parallel lines.

An enlarged side and top view of a tooth 999 are shown in FIGS. 33C-33D, illustrating depth, rake angle, and tooth width. In the tooth 999 shown in FIG. 33A-33D, the tooth depth gradually linearly increases with the tooth width. When viewed from the side, the tooth has a ramp shape. Additionally, the tooth width (M) at the start of the tooth is less than the tooth width (W) at the end (or peak) of the tooth. When viewed from the top, the tooth 999 has the shape of an isosceles trapezoid.

However, the shape of the tooth or gripping feature from the side and top view may vary. For example, without limitation, the shape of the tooth or feature from the top may include square, rectangle, triangle, trapezoid, circle, star, pentagon. And the shape of the tooth or feature from the side may include without limitation a ramp whether linear or curved, triangle, semicircular, and square.

Additionally, although the teeth are shown as being identical on a single tool, the teeth need not be identical. The teeth may vary within a roller or, within a row, as desired to peel the produce.

In embodiments, non-limiting exemplary dimensions for a peeling tool are any one or combination of the following: Diameter: 20-50 mm and more preferably 25-40 mm; Depth: 1-5 mm and more preferably 1-3 mm; Tooth width: 1-5 mm and more preferably 1-3 mm; Rake angle: −100 to −60 deg., and more preferably −30 to −40 deg; Edge Radius: generally rounded or about 0.1 mm; Angular/Circular Pitch: 20-50 deg and more preferably 25-35 deg; Circular Phase Offset: 5-30 deg and more preferably 10-25 deg; and Linear Pitch: less than 30 mm and more preferably 5-20 mm. In embodiments, a ratio of the minor tooth width (M):major tooth width (W) ranges from 0.1 to 0.9, and more preferably from 0.5 to 0.8.

However, it is to be understood that the roller surface design and dimensions may vary widely and are only intended to be limited as recited in any appended claims. Indeed, the teeth themselves, arrangement or pattern of teeth, or other surface geometry can be modified in any way to better grab onto the skin of the produce to be peeled. The shape of the teeth, rake angle of the teeth, ratio of the teeth height to tool diameter, linear pitch, circular pitch, phase offset, etc. can be optimized to maximize the adherence with the peeling element of the produce (e.g., the avocado, mango, plum or peach skin) while lowering the likelihood of skin tear and the gap between tools (thus increasing yield). For example, atraumatic or smooth surfaces (or merely roughed, sandblasted, etc.) can be adopted for the plum or peach skins whereas more penetrating features (e.g., barbs or teeth) are adopted for tougher skins such as the avocado and mango skin.

### Examples

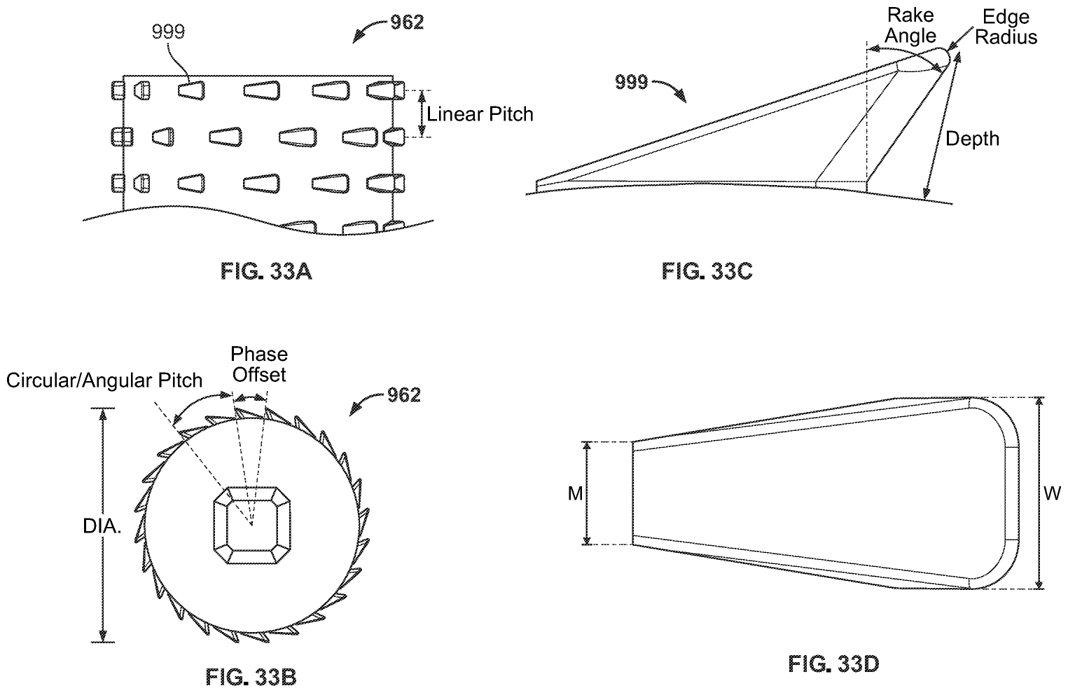

With reference to FIGS. 34-40, various peeling tools were built and tested for extracting flesh from the skin of an avocado. Characteristics and dimensions of each of the peeling tools are shown in Table 1 below:

TABLE 1

| | | Roller | | | Max | Cir | Phase | Lin |
|---|---|---|---|---|---|---|---|---|
| FIG. | Tooth | cross | DIA. | Depth | Width | Pitch | Offset | Pitch |
| Nos. | shape | section | (mm) | (mm) | (mm) | (deg.) | (deg.) | (mm) |
| 34A- | Trap | Circle | 32 | 1.5 | 2 | 30 | 15 | 10 |
| 34D | | | | | | | | |
| 35A- | Trap | Circle | 32 | 1.5 | 3 | 30 | 15 | 15 |
| 35D | | | | | | | | |
| 36A- | Trap/Tri | Circle | 35 | 1.5 | 3 | 30 | 15 | 15 |
| 36D | | | | | | | | |
| 37A- | Triangle | Circle | 35 | 2.5 | 5 | 45 | 22.5 | 20 |
| 37D | | | | | | | | |
| 38A- | Ridged | Pentagon | | 3.6 | | | | |
| 38D | | | | | | | | |
| 39A- | Grooves | Star | | 3 | | | | |
| 39D | | | | | | | | |
| 40A- | Threads | Star | | 3 | | | | |
| 40D | | | | | | | | |

Each of the designs extracted flesh from a skin of an avocado. Preferred surface designs comprise a set of features having a ramped trapezoidal (“Trap”) shape and arranged in parallel lines across a cylindrical roller. However, as described herein, the invention may include alternative embodiments except as recited in any specific appended claims.

Food Storage and Waste Management

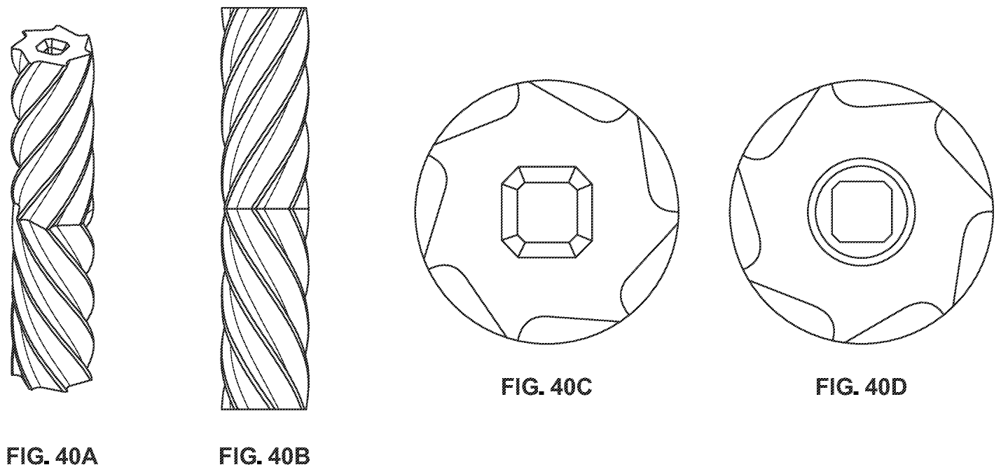

Step 1182 states to collect flesh and skin. With reference to FIGS. 41-44, a food storage and waste management assembly 1000 is shown in accordance with embodiments of the invention. The assembly 1000 consists of an outer frame 1002, optionally in the shape of a drawer. The frame defines multiple regions, some of which are dedicated for waste 1012, 1014 (e.g., seeds, pits and skins) and some dedicated for edible yield 1010 (e.g., avocado flesh), each of which holds a receptacle such as a bowl or pan.

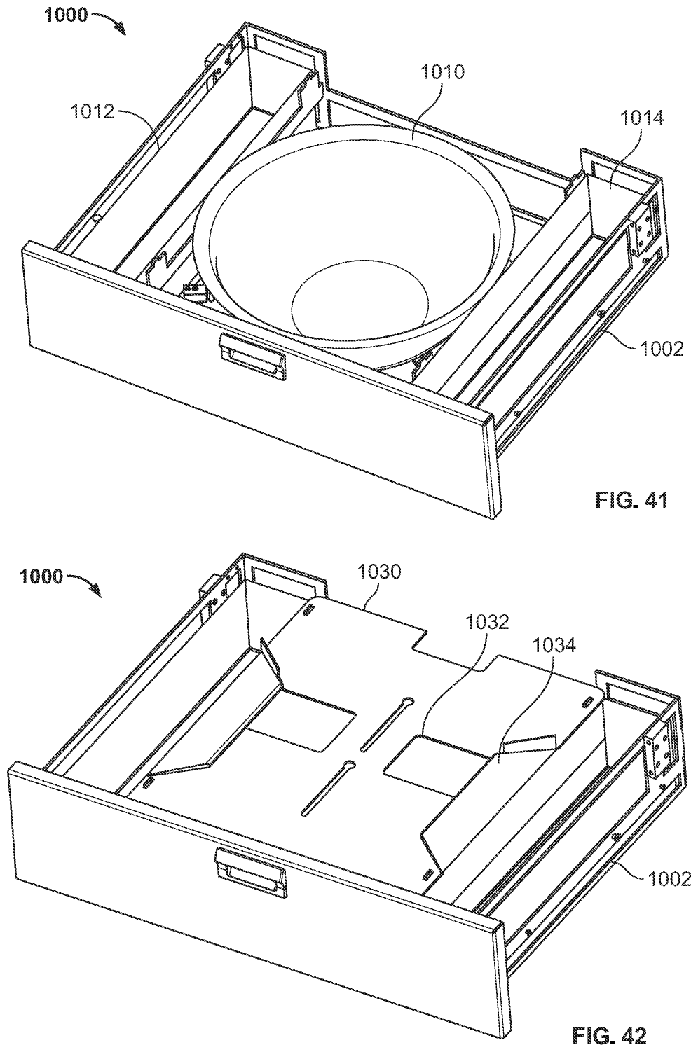

In the embodiment shown in FIG. 41, a large removable bowl 1010 is arranged in the main central area of the frame. Optionally, frame includes a motorized turntable or seat operable to rotate the bowl to evenly distribute the flesh as it is received by the bowl, discussed further herein. Removable waste containers 1012, 1014 are arranged in side areas of the frame. With reference to FIG. 42, a removable cover or top 1030 is coupled to the frame above the bowl and includes windows or openings 1032. The windows 1032 are shown above the bowl such that material that falls through the window lands in the bowl.

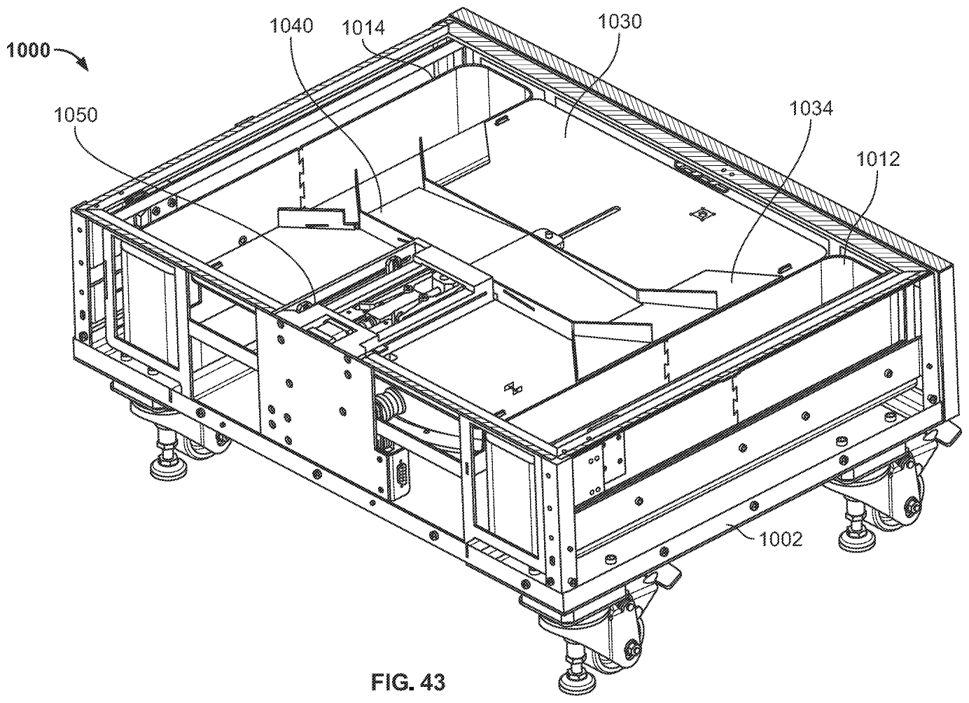

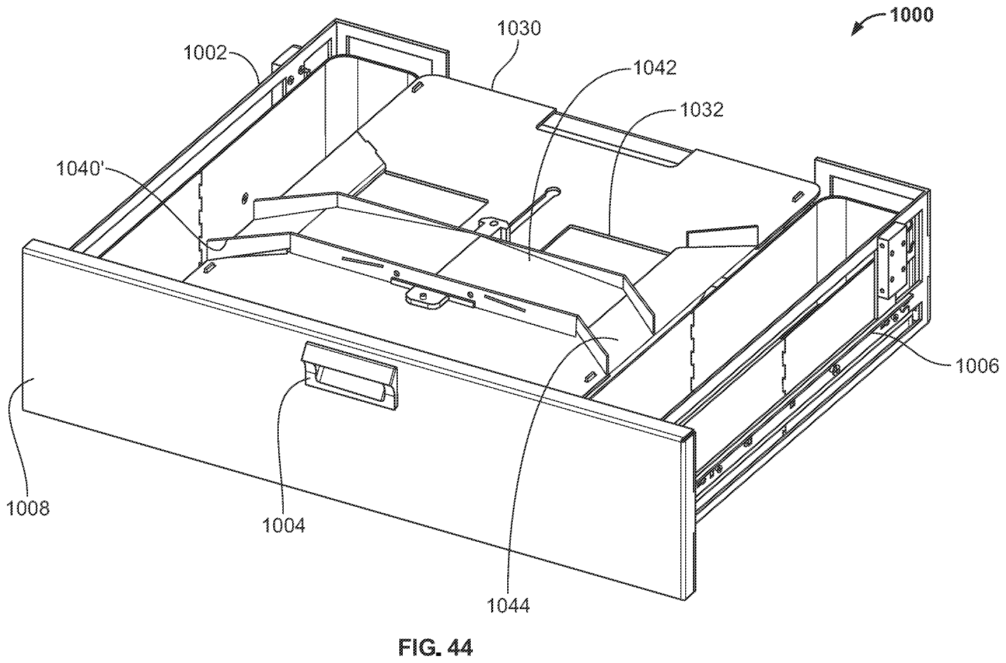

With reference to FIGS. 43-44, on top of the cover 1030 is a movable shutter 1040 capable of closing the windows 1032 to the bowl. The shutter 1040 is shown having a first ramp 1042 and second ramp section 1044 which slope towards the waste compartments 1012, 1014. The ramps include side walls to guide the material down the ramp.

During operation, the shutter 1040, 1040′ is operable to redirect waste to the waste compartments (e.g., the falling pits and skins to containers 1012, 1014) and to grant access to the edible yield compartment (e.g., the falling flesh to the bowl 1010 via windows 1032) as shown in FIGS. 43, 44, respectively.

The compartments can be operable to evenly distribute the edible yield and the waste therein. Non-limiting examples of assemblies for distributing the yield and waste include motorized turntables to rotate the bowl/pan in the compartment and vibratory agitation systems to vibrate the containers. Additionally, containers may be equipped with a load cell or optical sensor to detect mass or volume, respectively, and for computing and monitoring metrics.

Optionally, the frame 1002 is configured into a slidable drawer including a handle 1004, retractable rails 1006, and face 1008. FIG. 17, discussed above, illustrates the system with the drawer 1002 in an extended position, providing easy access to the contents inside the bowl 1010.

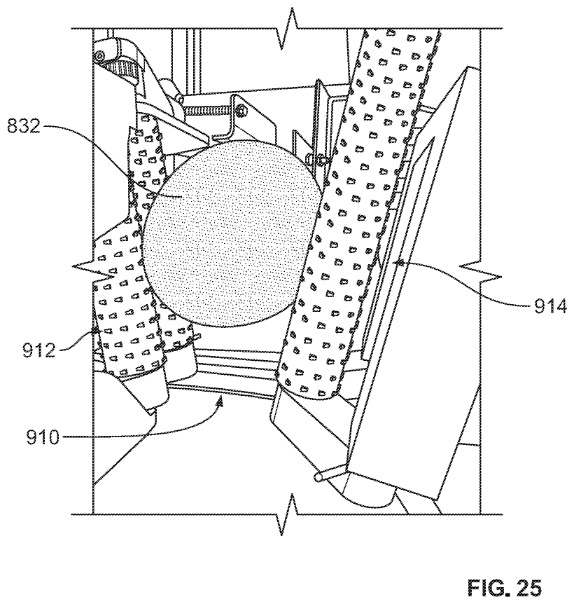

With reference again to the flow chart shown in FIG. 19, step 1190 states to return the fixture to home position. In embodiments, the avocado clamping fixture (e.g., peeling tools 912, 914) is returned to a home position for receiving the next avocado to be dispensed from the orientation assembly 870 as shown in FIGS. 24-25 above.

Step 1192 states to continue. This step can be performed by the processor determining whether the next avocado should be dispensed or singulated from the loading assembly to clamping fixture for cutting. Software logic for proceeding can include confirming by sensor or a clock data that an avocado or part of the avocado has passed to the next stage or handoff position. If ‘yes’, the method proceeds to step 1120 to singulate another avocado. If not, the method is halted 1194, and optionally, an operator is alerted via the dashboard or otherwise to check or power off the system.

Computer Processor and Metrics

Similar to the system described above in connection with FIG. 15, each of the assemblies may be controlled by standalone electronics or by a main computer or processor programmed and operable to carry out the functions described herein including loading, orienting, cutting, depitting, peeling, and food and waste collection.

Additionally, the system may be programmed and operable for integrated data tracking for metrics including flesh yield, total avocados processed, cycle time, and food safety or expiration. For example, the processor may be programmed to compute the above metrics based on sensor data for time elapsed, mass, volume, and avocado count.

### Alternative Embodiments

In embodiments of the invention, any one or combination of the ramps and chutes described herein may be motorized to further control singulation timing.

In embodiments of the invention, the system may be programmed and operable to collect and use feedback to compute the location of the object of interest along its path of travel. In a sense, the object of interest can be tracked.

In embodiments of the invention, the system can include additional sensors and/or vision directed at the various handoff points between stages to qualify and/or quantify attributes of the objects of interest (namely, the produce) where: (a) qualifying the object can include, but is not exclusive to: is the object damaged or bruised, what is the ripeness or visible exterior of the object, and orientation; and (b) quantifying the object can include, but is not exclusive to: weight and dimensions. Visions systems can include, e.g., camera(s) and a processor programmed with trained detection and classification models to perform the functions described herein.

In embodiments of the invention, various hardware components of the system are tracked. In one embodiment, an RFID tag is arranged on the component to be tracked. Examples of hardware components to be tracked include, without limitation, consumables such as the spinning peeling roller and cutting blades.

In embodiments of the invention, the system has pre-established quantified datasets for the average mechanical decay rate of each consumable or component to be tracked. As the system operates, the runtime and maturity of the components are tracked using, e.g., a unique ID sensed by the RFID receiver for each component.

In embodiments of the invention, the metrics and data tracking the system records are integrated with end customer Quick Service Restaurants (QSR) inventory and data pipelines. The metrics are uploaded to the QSR databases, providing real time data to help monitor efficiency of operations within the kitchens.

In embodiments of the invention, the system contains additional food safety capabilities such as and not limited to UV sanitizing lamps and heated surfaces to remove pathogens on the produce it processes as well as to prevent growth of pathogens within the machine

In embodiments of the invention, the system contains cooled compartments for the storage of raw produce and useful yield, thus increasing the duration of safe storage within the machine.

Additionally, in embodiments of the invention, the system is operable to evaluate whether a component is suitable for the object of interest based on comparing stored data for the component (e.g., cutout size of the avocado blade) and the size of the produce to be processed (e.g., large avocado). The size of the produce may be received by the system as input from the operator, or in some embodiments, automatically detected based on a sensor in which case an alert is created if the component is unsuitable for the produce.

Still other modifications and variations can be made to the disclosed embodiments without departing from the subject invention. For example, the avocado splitting system may have more or less functional stations and components than that shown and described herein. The system may also be modified to accommodate other food objects and produce and preferably, other pitted foods such as plums, peaches, mangoes, papayas, etc. Additionally, although reference was generally made herein to cutting the avocado into equal halves, it is to be understood that the invention may be directed to cutting the avocado into two parts that are not equal in size. One half may be slightly larger than the other half. For example, the second part initially containing the pit is preferably slightly larger than the first half.

1. An automated avocado processing system comprises:
a holding assembly to hold an avocado;
a loading assembly to load one avocado into the holding assembly from a plurality of avocados;
a cutting assembly to cut the avocado into parts while the avocado is held in the holding assembly; and
a food collection assembly to sort and collect edible parts from nonedible parts of the avocado.

2. The system of claim 1, wherein the holding assembly comprises a plurality of portions, and the plurality of portions are movable relative to one another to form an avocado-capture zone.

3. (canceled)

4. The system of claim 1, wherein the cutting assembly further comprises at least one opposing blade for cutting the avocado into a first part and a second part.

5. The system of claim 4, further comprising at least one of a motor and an actuator operable to separate the first part from the second part.

6. (canceled)

7. The system of claim 5, further comprising at least one elongate member arranged to penetrate at least one of the first part and the second part of the avocado.

8. The system of claim 7, wherein each of said first half and second half comprises a first tool operable to extract the flesh from the skin.

9. The system of claim 8, wherein the first tool comprises a pair of rotating members.

10. The system of claim 9, wherein the rotating members are separated by a gap having an adjustable size, and spring loaded to prevent the gap from freely spreading.

11. The system of claim 9, wherein each rotating member comprises a gripping feature.

12. The system of claim 9, wherein each pair of rotating members are controllable to turn such that when a skin-side of an avocado half is in contact with the pair of rotating members, the skin is drawn into the gap, and the flesh is extracted from the skin.

13. (canceled)

14. The system of claim 1, wherein the loading assembly comprises a hopper adapted to receive a plurality of avocados.

15. (canceled)

16. (canceled)

17. (canceled)

18. The system of claim 14, further comprising a drum for metering the avocados from the hopper to the loading assembly.

19. (canceled)

20. The system of claim 1, wherein the loading assembly further comprises an orientation assembly for centering a main axis of the avocado along a target axis and presenting the avocado to the cutting assembly.

21. (canceled)

22. The system of claim 20, wherein the centering mechanism comprises radially adjustable opposing funnel-shaped members.

23. The system of claim 20, wherein the orientation assembly comprises a release mechanism arranged below the centering mechanism.

24. (canceled)

25. (canceled)

26. (canceled)

27. (canceled)

28. (canceled)

29. (canceled)

30. (canceled)

31. The system of claim 1, wherein the food collection and holding assembly is configured as a retractable drawer.

32. The system of claim 1, further comprising a tracker arranged on a consumable component for tracking usage of the consumable component.

33. (canceled)

34. (canceled)

35. (canceled)

36. (canceled)

37. The system of claim 1 further comprising a computing device, power supply, and a plurality of sensors programmed and operable to control the loading, cutting and food collection assemblies.

38. (canceled)

39. (canceled)

40. (canceled)

41. A method for processing an avocado comprises the steps of:
engaging the avocado in a separable fixture;
cutting the avocado;
pulling the avocado apart into a first part and second part; and
depitting the avocado.

42. (canceled)

43. The method of claim 41, further comprising extracting the flesh from the skin.

44.-59. (canceled)
